(19) United States
(12) Patent Application Publication
(10) Pub. No.: US 2009/0249558 A1
(43) Pub. Date: Oct. 8, 2009

(54) Washing- Or Cleaning-Agent Delivery System

(75) Inventors: Salvatore Fileccia, Oberhausen (DE); Rene-Andres Artiga Gonzalez, Duesseldorf (DE); Georg Meine, Mettmann (DE); Wolfgang Barthel, Langenfeld (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/417,163

(22) Filed: Apr. 2, 2009

Related U.S. Application Data
(63) Continuation of application No. PCT/EP2007/059632, filed on Sep. 13, 2007.

(30) Foreign Application Priority Data
Oct. 4, 2006 (DE) 10 2006 047 229.2

(51) Int. Cl. C11D 17/04; B65D 83/04; B32B 37/00; D06F 39/02

(52) U.S. Cl. 8/137; 221/282; 156/538; 29/592

(57) ABSTRACT

A washing- or cleaning agent delivery system for washing—or cleaning agent shaped elements is described. The shaped elements are well suited for spot treatment, for example on textiles but also on hard surfaces. The shaped elements are also suitable for the preparation of washing baths.

### CROSS-REFERENCE TO RELATED APPLICATIONS

This application is a continuation under 35 U.S.C. §§ 120 and 365(c) of International Application PCT/EP2007/059632, filed on Sep. 13, 2007. This application also claims priority under 35 U.S.C. § 119 of DE 10 2006 047 229.2, filed on Oct. 4, 2006. The disclosures of PCT/EP2007/059632 and 10 2006 047 229.2 are incorporated herein by reference in their entirety.

### BACKGROUND OF THE INVENTION

The present invention relates to a washing- or cleaning-agent delivery system for polymer-containing shaped elements that are strip-shaped, sheet-shaped, disk-shaped, layer-shaped, plate-shaped, or web-shaped, and to the use thereof for individual dosing of non-liquid washing or cleaning agents. The invention further relates to a method for manufacturing an aqueous system having cleaning ability, and to a method for local spot treatment of substrates.

Liquid and solid washing and cleaning agents have been welcome adjuvants in households and businesses for many years, and are used as a matter of course by almost everyone.

There exists among consumers, however, a constant demand for products that are particularly user-friendly and easy to handle.

### DESCRIPTION OF THE INVENTION

The object of the present invention was therefore to make available a particularly user-friendly and easily handled washing or cleaning agent. This object is achieved by the subject matter of the invention.

The subject matter of the present invention is a washing- or cleaning-agent delivery system comprising a strip-shaped, sheet-shaped, disk-shaped, layer-shaped, plate-shaped, or web-shaped washing- or cleaning-agent shaped element that is made up of at least 20 wt % polymers and comprises a substance having cleaning ability, the shaped element being made available in a withdrawal receptacle.

A washing- or cleaning-agent delivery system for purposes of the invention is an object that comprises at least one withdrawal receptacle in which a washing- or cleaning-agent shaped element according to the present invention, by preference such as a film, is contained. The washing- or cleaning-agent shaped element contains at least one substance having cleaning ability, in particular a bleaching agent, optical brightener, and/or surfactant. Optical brighteners do not in fact possess any actual cleaning ability, but because they convert ultraviolet light into longer-wave light they can cause brightening and at the same time produce the impression of a bleaching effect, so that they are nevertheless included, within the scope of this invention, among the substances having cleaning ability.

The strip-shaped, sheet-shaped, disk-shaped, layer-shaped, or web-shaped washing- or cleaning-agent shaped element is by preference to be understood as a foil or film.

According to a preferred embodiment, the polymer proportion of the shaped element can also be well above 20 wt %, e.g. can have a value of at least 25 wt %, 30 wt %, 35 wt %, 40 wt %, 45 wt %, 50 wt %, 55 wt %, 60 wt %, 65 wt %, 70 wt %, or even at least 75 wt % or in fact at least 80 wt % (wt % based on the entire shaped element. Possible upper limits for the polymer proportion of the shaped element can lie, for example at a value of at most 95 wt %, 90 wt %, 85 wt %, 80 wt %, 75 wt %, 70 wt %, 65 wt %, 60 wt %, 55 wt %, 50 wt %, 45 wt %, 40 wt %, 35 wt %, or at most 30 wt %. The polymer proportion of the shaped element can thus be, for example, in the range from 35 wt % to 70 wt % or, for example, in the range from 40 wt % to 80 wt %, etc.

According to a preferred embodiment, the shaped element according to the present invention can be water-soluble or water-soluble; conversely, according to another embodiment, water-insoluble, although this is less preferred. It is also possible for it to be water-soluble or water-dispersible only in part. For example, a shaped element according to the present invention such as, for example, a film, can be of multiple-ply construction, for example in the manner of a laminate, different plies differing also in terms of their water-solubility. This can refer, for example, to a two-ply film in which the one ply is water-soluble and/or water-dispersible, whereas the other ply is water-insoluble. It may also be that the shaped element according to the present invention, by preference the film, is coated, so that the actual shaped-element material, by preference film material, constituting a carrier of the layer, is water-insoluble, whereas the coating is water-soluble. Conversely, it is possible for the coating to be water-insoluble but the shaped-element, by preference the film, to be water-soluble.

The shaped element can thus, according to a preferred embodiment, be made up of a single (material) ply or of a laminate comprising more than one ply; by preference, the shaped element, multiple-ply if applicable, is coated. According to a further preferred embodiment, the shaped element comprises a film made of preferably flexible material, and a substance having cleaning ability that is applied in the film and/or as a layer on the film.

The shaped element according to the present invention can also contain, in addition to the polymer and the substance having cleaning ability, other constituents such as, for example, natural and/or synthetic fabric, nonwoven fabrics, films, paper, rubber, and combinations thereof. The polymer that is contained can be, for example, a single polymer or a mixture of different polymers. Suitable polymers can encompass, for example, polyethylene, polyvinyl alcohol, ethyl vinyl acetate, ethyl vinyl alcohol, polyester, etc. A preferred water-insoluble material is, for example, polyethylene. A preferred water-soluble polymer is, for example, polyvinyl alcohol.

Examples of suitable shaped-element materials are, for example, films or foils made of synthetic resins such as, for example, PE, PP, PAN, PUR, PVA, PVC, PA, etc., as well as laminated films thereof, porous films or foils made of rubber and/or synthetic resins. Fiber films or foils such as so-called nonwoven textile materials (i.e. planar textile structures that are not woven or knitted, preferably based on PP, polyester, viscose, acrylic fibers, polyamide), textile materials, and paper, as well as metal foils, are likewise suitable.

In preferred cases, the shaped element comprises one or more materials from the group of (optionally acetalized) polyvinyl alcohol (PVAL) and/or PVAL copolymers, polyvinylpyrrolidone, polyethylene oxide, polyethylene glycol, gelatin, cellulose and derivatives thereof, in particular MC, HEC, HPC, HPMC and/or CMC, and/or copolymers, and mixtures thereof. By preference, it is also possible to mix into the shaped elements plasticizers known to one skilled in the art in order to increase the flexibility of the material, or also other adjuvants or additives.

Polyvinyl alcohols are very particularly preferred in the context of the present invention as water-soluble polymers. “Polyvinyl alcohols” (abbreviated PVAL, occasionally also PVOH) is the designation for polymers having the general structure

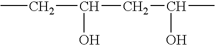

that also contain small proportions (approx. 2%) of structural units of the following type.

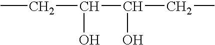

Commercially usual polyvinyl alcohols, which are offered as yellowish-white powders or granulates having degrees of polymerization in the range from approx. 100 to 2500 (molecular weights from approx. 4000 to 100,000 g/mol), have degrees of hydrolysis of 98 to 99 or 87 to 89 mol %, i.e. still have a residual content of acetyl groups. Polyvinyl alcohols are characterized by manufacturers by indicating the degree of polymerization of the initial polymer, the degree of hydrolysis, the saponification value, or the solution viscosity.

Depending on their degree of hydrolysis, polyvinyl alcohols are soluble in water and in a few highly polar organic solvents (formamide, dimethylformamide, dimethylsulfoxide); they are not attacked by (chlorinated) hydrocarbons, esters, fats, and oils. Polyvinyl alcohols are classified as toxicologically harmless and are at least partly biodegradable. The water solubility can be decreased by post-treatment with aldehydes (acetalization), by complexing with Ni or Cu salts, or by treatment with dichromates, boric acid, or borax. Polyvinyl alcohol is largely impenetrable to gases such as oxygen, nitrogen, helium, hydrogen, and carbon dioxide, but allows water vapor to pass through.

Shaped elements that are preferred in the context of the present invention are characterized in that they encompass polyvinyl alcohols and/or PVAL copolymers whose degree of hydrolysis is 70 to 100 mol %, by preference 80 to 90 mol %, particularly preferably 81 bis 89 mol %, and in particular 82 to 88 mol %.

By preference, polyvinyl alcohols of a specific molecular-weight range are used; those whose molecular weight is in the range from 3,500 to 100,000 gmol⁻¹, by preference from 10,000 to 90,000 gmol⁻¹, particularly preferably from 12,000 to 80,000 gmol⁻¹, and in particular from 13,000 to 70.000 gmol⁻¹, are preferred.

The degree of polymerization of such preferred polyvinyl alcohols is between approximately 200 and approximately 2100, by preference between approximately 220 and approximately 1890, particularly preferably between approximately 240 and approximately 1680, and in particular between approximately 260 and approximately 1500.

Shaped elements preferred according to the present invention are characterized in that they encompass polyvinyl alcohols and/or PVAL copolymers whose average degree of polymerization is between 80 and 700, by preference between 150 and 400, particularly preferably between 180 and 300, and/or whose molecular weight ratio MW(50%): MW(90%) is between 0.3 and 1, by preference between 0.4 and 0.8, and in particular between 0.45 and 0.6.

The polyvinyl alcohols described above are widely available commercially, for example under the trademark Mowiol® (Clariant). Polyvinyl alcohols that are particularly suitable in the context of the present invention are, for example, Mowiol® 3-83, Mowiol® 4-88, Mowiol® 5-88, and Mowiol® 8-88.

Further polyvinyl alcohols that are particularly suitable as a material for the shaped elements are evident from the table below:

| | Degree of | Molecular | Melting |
|---|---|---|---|
| Designation | hydrolysis (%) | weight (kDa) | point (° C.) |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Further polyvinyl alcohols suitable as a material for the shaped elements are ELVANOL® 51-05, 52-22, 50-42, 85-82, 75-15, T-25, T-66, 90-50 (trademarks of Du Pont), ALCOTEX® 72.5, 78, B72, F80/40, F88/4, F88/26, F88/40, F88/47 (trademarks of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademarks of Nippon Gohsei K.K.). The ERKOL grades of Wacker are also suitable.

A further preferred group of water-soluble polymers that can be contained according to the present invention in the shaped elements are the polyvinylpyrrolidones. These are marketed, for example, under the designation Luviskol® (BASF). Polyvinylpyrrolidone [poly(1-vinyl-2-pyrrolidinones)], abbreviated PVP, are polymers of the general formula (I)

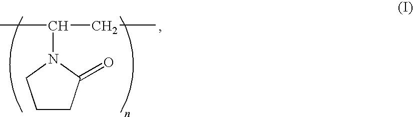

that are produced by radical polymerization of 1-vinylpyrrolidone in accordance with solution or suspension polymerization methods using radical formers (peroxides, azo compounds) as initiators. Ionic polymerization of the monomer yields only products having low molar weights. Commercially usual polyvinylpyrrolidones have molar weights in the range from approx. 2500 to 750,000 g/mol; they are characterized by indication of the K values, and possess glass transition temperatures of 130 to 175° C. (depending on K value). They are offered as white, hygroscopic powders or as aqueous solutions. Polyvinylpyrrolidones are readily soluble in water and a plurality of organic solvents (alcohols, ketones, glacial acetic acid, chlorinated hydrocarbons, phenols, and others).

Also suitable are copolymers of vinylpyrrolidone with other monomers, in particular vinylpyrrolidone/vinyl ester copolymers, such as those marketed e.g. under the trademark Luviskol® (BASF). Luviskol® VA 64 and Luviskol® VA 73, each vinylpyrrolidone/vinyl acetate copolymers, are particularly preferred nonionic polymers.

The vinyl ester polymers are polymers, accessible from vinyl esters, having the grouping of formula (II)

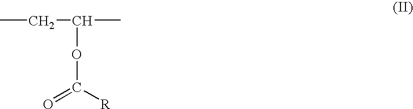

as a characteristic basic module of the macromolecules. Of these, the vinyl acetate polymers (R=CH₃) with polyvinyl acetates are by far the most important representatives having the greatest industrial significance. Polymerization of the vinyl esters is accomplished radically in accordance with various methods (solution polymerization, suspension polymerization, emulsion polymerization, substance polymerization). Copolymers of vinyl acetate with vinylpyrrolidone contain monomer units of formulas (I) and (II).

Further suitable water-soluble polymers are the polyethylene glycols (polyethylene oxides), which are abbreviated PEG. PEGs are polymers of ethylene glycol that conform to the general formula (III)

H—(O—CH₂—CH₂)ₙ—OH (III),

in which n can assume values between 5 and >100,000.

PEGs are manufactured industrially by anionic ring-opening polymerization of ethylene oxide (oxirane), usually in the present of small quantities of water. Depending on how the reaction proceeds, they have molecular weights in the range from approx. 200 to 5,000,000 g/mol, corresponding to degrees of polymerization from approx. 5 to >100 000.

The products having molar weights below approx. 25,000 g/mol are liquid at room temperature and are referred to as actual polyethylene glycols (abbreviated PEG). These short-chain PEGs can have, in particular, other water-soluble polymers, for example polyvinyl alcohols or cellulose ethers, added to them as a plasticizer. The polyethylene glycols usable according to the present invention, which are solid at room temperature, are referred to as polyethylene oxides (abbreviated PEOX). High-molecular-weight polyethylene oxides possess an extremely low concentration of reactive hydroxy terminal groups, and therefore exhibit only weak glycol properties.

Also suitable according to the present invention as a material for the shaped elements is gelatin, the latter being used by preference together with other polymers. Gelatin is a polypeptide (molar weight: approx. 15,000 to >250,000 g/mol) that is obtained principally by hydrolysis, under acid or alkaline conditions, of the collagen contained in animal skin and bones. The amino acid composition of gelatin corresponds largely to that of the collagen from which it was obtained, and varies as a function of its provenience. The use of gelatin as a water-soluble encasing material is extremely widespread especially in the pharmacy sector, in the form of hard or soft gelatin capsules. Gelatin is generally little used in the form of films because of its high price as compared with the polymers cited above.

Further water-soluble polymers that are suitable according to the present invention are described below:

Cellulose ethers, such as hydroxypropyl cellulose, hydroxyethyl cellulose, and methylhydroxypropyl cellulose, such as those marketed, for example, under the trademarks Culminal® and Benecel®5 (AQUALON). Cellulose ethers can be described by the general formula (IV)

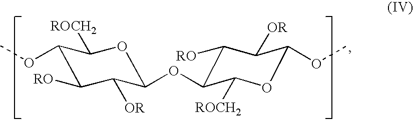

in which R denotes H or an alkyl, alkenyl, alkinyl, aryl, or alkylaryl radical. In preferred products, at least one R in formula (III) denotes —CH₂CH₂CH₂—OH or —CH₂CH₂—OH. Cellulose ethers are produced industrially by the etherification of alkaline celluloses (e.g. with ethylene oxide). Cellulose ethers are characterized by way of the average degree of substitution DS or the molar degree of substitution MS, which indicate respectively how many hydroxy groups of an anhydroglucose unit of the cellulose have reacted with the etherification reagent, and how many moles of the etherification reagent have attached, on average, to an anhydroglucose unit. Hydroxyethyl celluloses are water-soluble above a DS of approximately 0.6 or an MS of approximately 1. Commercially usual hydroxyethyl and hydroxypropyl celluloses have degrees of substitution in the range of 0.85 to 1.32 (DS) or 1.5 to 3 (MS). Hydroxyethyl and hydroxypropyl celluloses are marketed as yellowish-white, odorless and tasteless powders, in a great variety of degrees of polymerization. Hydroxyethyl and hydroxypropyl celluloses are soluble in cold and hot water and in some (hydrous) organic solvents, but insoluble in most (anhydrous) organic solvents; their aqueous solutions are relatively insensitive to changes in pH or to electrolyte addition.

Preferred shaped elements according to the present invention are characterized in that they encompass hydroxypropylmethyl cellulose (HPMC) that has a degree of substitution (average number of methoxy groups per anhydroglucose unit of the cellulose) from 1.0 to 2.0, by preference from 1.4 to 1.9, and a molar substitution (average number of hydroxypropoxyl groups per anhydroglucose unit of the cellulose) from 0.1 to 0.3, by preference from 0.15 to 0.25.

Further polymers suitable according to the present invention are water-soluble amphopolymers. The general term “amphopolymers” comprises amphoteric polymers, i.e. polymers that contain in the molecule both free amino groups and free —COOH or SO₃H groups and are capable of forming internal salts, zwitterionic polymers, which contain quaternary ammonium groups and —COO⁻ or —SO⁻ groups in the molecule, and those polymers that contain —COOH or SO₃H groups and quaternary ammonium groups. One example of an amphopolymer usable according to the present invention is the acrylic resin obtainable under the name Amphomer®, which represents a copolymer of tert.-butylaminoethyl methacrylate, N-(1,1,3,3-tetramethylbutyl)acrylamide, and two or more monomers from the group of acrylic acid, methacrylic acid, and simple esters thereof. Similarly preferred amphopolymers are made up of unsaturated carboxylic acids (e.g. acrylic and methacrylic acid), cationically derivatized unsaturated carboxylic acids (z.B. acrylamidopropyltrimethylammonium chloride), and if applicable further ionic or nonionogenic monomers. Terpolymers of acrylic acid, methyl acrylate, and methacrylamidopropyltrimonium chloride, such as those available commercially under the name Merquat®2001 N, are amphopolymers that are particularly preferred according to the present invention. Further suitable amphoteric polymers are, for example, the octyl-acrylamide/methyl methacrylate/tert.-butylaminoethyl methacrylate/2-hydroxypropyl methacrylate copolymers available under the names Amphomer® and Amphomer® LV-71 (DELFT NATIONAL).

Water-soluble anionic polymers that are suitable according to the present invention are, among others:
Vinyl acetate/crotonic acid copolymers such as those marketed, for example, under the names Resyn® (NATIONAL STARCH), Luviset® (BASF) and Gafset® (GAF).
   In addition to monomer units of the aforesaid formula (II), these polymers also have monomer units of the general formula (V):

[—CH(CH₃)—CH(COOH)—]ₙ (V)
Vinylpyrrolidone/vinyl acrylate copolymers obtainable, for example, under the trade name Luviflex® (BASF). A preferred polymer is the vinyl-pyrrolidone/acrylate terpolymers obtainable under the name Luviflex® VBM-35 (BASF).
Acrylic acid/ethyl acrylate/N-tert.-butylacrylamide terpolymers such as those marketed, for example, under the name Ultraholdo strong (BASF).
Graft polymers of vinyl esters, esters of acrylic acid or methacrylic acid alone or mixed, copolymerized with crotonic acid, acrylic acid, or methacrylic acid with polyalkylene oxides and/or polykalkylene glycols.
   Grafted polymers of this kind, of vinyl esters, esters or acrylic acid or methacrylic acid, alone or mixed with other copolymerizable compounds on polyalkylene glycols, are obtained by hot polymerization in a homogeneous phase by mixing the polyalkylene glycols into the monomers of the vinyl esters or esters of acrylic acid or methacrylic acid in the presence of radical formers. Vinyl esters that have proven suitable are, for example, vinyl acetate, vinyl propionate, vinyl butyrate, vinyl benzoate; and esters of acrylic acid or methacrylic acid that have proven successful are those that are obtainable with low-molecular-weight aliphatic alcohols, i.e. in particular ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol; 3-methyl-2-butanol, 2-methyl-2-butanol, 2-methyl-1-butanol, 1-hexanol.

Polypropylene glycols (abbreviated PPG) are polymers of propylene glycol that conform to the general formula (VI)

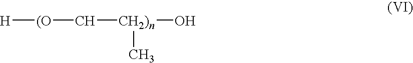

in which n can assume values between 1 (propylene glycol) and several thousand. Di-, tri-, and tetrapropylene glycol, i.e. the representatives having n=2, 3, and 4 in formula (VI), are of particular technical significance here. The vinyl acetate copolymers grafted onto polyethylene glycols, and the polymers of vinyl acetate and crotonic acid grafted onto polyethylene glycols, can be used in particular.
Grafted and cross-linked copolymers from the copolymerization of
i) at least one monomer of the nonionic type,
ii) at least one monomer of the ionic type,
iii) polyethylene glycol, and
iv) a crosslinker.
   The polyethylene glycol used has a molecular weight between 200 and several million, by preference between 300 and 30,000.

The nonionic monomers can be of very different types, and among them the following are preferred: vinyl acetate, vinyl stearate, vinyl laurate, vinyl propionate, allyl stearate, allyl laurate, diethyl maleate, allyl acetate, methyl methacrylate, cetyl vinyl ether, stearyl vinyl ether, and 1-hexene.

The nonionic monomers can similarly be of very different types; among them crotonic acid, allyloxyacetic acid, vinylacetic acid, maleic acid, acrylic acid, and methacrylic acid can particularly preferably be contained in the graft polymers.

The crosslinkers used are preferably ethylene glycol dimethacrylate, diallyl phthalate, ortho-, meta- and paradivinylbenzene, tetraallyloxyethane, and polyallylsucroses having 2 to 5 allyl groups per molecule of saccharin.

The above-described grafted and crosslinked copolymers are preferably constituted from:
i) 5 to 85 wt % of at least one monomer of the nonionic type,
ii) 3 to 80 wt % of at least one monomer of the ionic type,
iii) 2 to 50 wt %, preferably 5 to 30 wt %, polyethylene glycol, and
iv) 0.1 to 8 wt % of a crosslinker, the percentage of the crosslinker being constituted by the ratio of the total weights of i), ii), and iii)
Copolymers obtained by copolymerization of at least one monomer of each of the three following groups:
i) esters of unsaturated alcohols and short-chain saturated carboxylic acids and/or esters of short-chain saturated alcohols and unsaturated carboxylic acids,
ii) unsaturated carboxylic acids,
iii) esters of long-chain carboxylic acids and unsaturated alcohols and/or esters of the carboxylic acids of group ii) with saturated or unsaturated, straight-chain or branched C₈₋₁₈ alcohol.
   “Short-chain” carboxylic acids and alcohols are to be understood in this context as those having 1 to 8 carbon atoms, in which context the carbon chains of these compounds can optionally be interrupted by double-bond hetero groups such as —O—, —NH—, —S.
Terpolymers of crotonic acid, vinyl acetate, and an allyl or methallyl ester. These terpolymers contain monomer units of the general formulas (II) and (IV) (see above), as well as monomer units of one or more allyl or methyallyl esters of formula (VII):

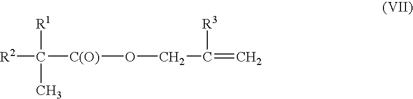

in which R³ denotes —H or —CH₃, R² denotes —CH₃ or —CH(CH₃)₂, and R¹ denotes —CH₃ or a saturated straight-chain or branched C₁₋₆ alkyl radical, and the sum of the carbon atoms in radicals R¹ and R² is preferably 7, 6, 5, 4, 3, or 2.

The aforesaid terpolymers preferably result from the copolymerization of 7 to 12 wt % crotonic acid, 65 to 86 wt %, preferably 71 to 83 wt %, vinyl acetate, and 8 to 20 wt %, preferably 10 to 17 wt %, allyl or methallyl esters of formula (VII).

Tetra- and pentapolymers of
i) crotonic acid or allyloxyacetic acid
ii) vinyl acetate or vinyl propionate
iii) branched allyl or methallyl esters
iv) vinyl ethers, vinyl esters, or straight-chain allyl or methallyl esters.

Crotonic acid copolymers having one or more monomers from the group of ethylene, vinyl benzene, vinyl methyl ether, acrylamide, and water-soluble salts thereof.

Terpolymers of vinyl acetate, crotonic acid, and vinyl esters of a saturated aliphatic branched monocarboxylic acid.

Further polymers preferred for use are cationic polymers. Among the cationic polymers, the permanently cationic polymers are preferred. According to the present invention, those polymers that possess a cationic group regardless of pH are referred to as “permanently cationic.” These are, as a rule, polymers that contain a quaternary nitrogen atom, for example in the form of an ammonium group.

Preferred cationic polymers are, for example: quaternized cellulose derivatives such as those obtainable commercially under the designations Celquat® and Polymer JR®. The compounds Celquat® H 100, Celquat® L 200, and Polymer JR® 400 are preferred quaternized cellulose derivatives;

polysiloxanes having quaternary groups, such as, for example, the commercially obtainable products Q2-7224 (manufacturer: Dow Corning; a stabilized trimethylsilylamodimethicone), Dow Corning® 929 Emulsion (containing a hydroxylamino-modified silicone that is also referred to as Amodimethicone), SM-2059 (manufacturer: General Electric), SLM-55067 (manufacturer: Wacker), and Abil®-Quat 3270 and 3272 (manufacturer: Th. Goldschmidt; diquaternary polydimethylsiloxanes, Quaternium-80);
cationic guar derivatives such as, in particular, the products marketed under the trade names Cosmedia® Guar and Jaguar®;
polymeric dimethyldiallylammonium salts and copolymers thereof with esters and amides of acrylic acid and methacrylic acid. The products available commercially under the designations Merquat® 100 (poly(dimethyldiallylammonium chloride)) and Merquat® 550 (dimethyldiallylammonium chloride/acrylamide copolymer) are examples of such cationic polymers;
copolymers of vinylpyrrolidone with quaternized derivatives of dialkylaminoalkyl acrylate and methacrylate, such as, for example, vinylpyrrolidone/dimethylaminoethyl methacrylate copolymers quaternized with diethyl sulfate. Such compounds are obtainable commercially under the designations Gafquat® 734 and Gafquat® 755;
vinylpyrrolidone/methoimidazolinium chloride copolymers, such as those offered under the designation Luviquat®;
quaternized polyvinyl alcohol; and
the polymers known by the names

### Polyquaternium-2,

### Polyquaternium-17,

### Polyquaternium-18, and

### Polyquaternium-27,

having quaternary nitrogen atoms in the main polymer chain. The aforesaid polymers are referred to in accordance with so-called INCI nomenclature.

Cationic polymers preferred according to the present invention are quaternized cellulose derivatives as well as polymeric dimethydiallylammonium salts and copolymers thereof. Cationic cellulose derivatives, in particular the commercial product Polymer® JR 400, are very particularly preferred cationic polymers.

The shaped-element material or film material can contain, in addition to the water-soluble polymer or water-dispersible polymer, further ingredients that, in particular, improve the processability of the starting materials for the film. Plasticizers and release agents are to be mentioned here in particular. Dyes can furthermore be incorporated into the film in order to achieve aesthetic effects therein.

Suitable release agents, which by preference can be applied onto the finished, dried films, are e.g. talc, starch, or (physically, chemically, and/or enzymatically) modified starch. Suitable chemical modifications are, for example, crosslinking, acetylation, esterification, hydroxyethylation, hydroxypropylation, phosphorylation. The preferably hydrophobic release agent adheres, in particular, on the exterior of the film.

Treatment of the films with a powdered release agent can effectively prevent possible sticking of the films, for example as a consequence of storage or high relative humidity.

Plasticizers that can be used according to the present invention are, in particular, hydrophilic, high-boiling liquids; if applicable, substances that are solid at room temperature can also be used as a solution, dispersion, or melt. Particularly preferred plasticizers derive from the group of glycol, di-, tri-, tetra-, penta-, hexa-, hepta-, octa-, nona-, deca-, undeca-, dodecaethylene glycol, glycerol, neopentyl glycol, trimethylolpropane, pentaerythritol, mono-, di-, triglycerides, surfactants, in particular nonionic surfactants, and mixtures thereof. Plasticizers are used by preference in quantities from 1 to 50 wt %, by preference 2 to 40 wt %, in particular 5 to 30 wt %, based on the entire shaped element.

Ethylene glycol (1,2-ethanediol, “glycol”) is a colorless, viscous, sweet-tasting, highly hygroscopic liquid that is miscible with water, alcohols, and acetone and has a specific gravity of 1.113. The solidification point of ethylene glycol is −11.5° C.; the liquid boils at 198° C. Ethylene glycol is obtained industrially from ethylene oxide by heating with water under pressure. Promising manufacturing methods can be based on the acetoxylation of ethylene and subsequent hydrolysis, or on synthesis gas reactions.

Diethylene glycol (2,2′-oxydiethanol, Digol), HO—(CH₂)₂—O—(CH₂)₂—OH, is a colorless, viscous, hygroscopic, sweet-tasting liquid, specific gravity 1.12, that melts at −6° C. and boils at 245° C. Diglycol is miscible at any ratio with water, alcohols, glycol ethers, ketones, esters, and chloroform, but not with hydrocarbons and oils. Diethylene glycol (usually abbreviated “diglycol” in practice) is manufactured from ethylene oxide and ethylene glycol (ethoxylation), and is thus in practice the starting stock for polyethylene glycol (see above).

Glycerol is a colorless, clear, slow-moving, odorless, sweet-tasting, hygroscopic liquid of specific gravity 1.261 that solidifies at 18.2° C. Glycerol was originally simply a byproduct of fat saponification, but today is synthesized industrially in large quantities. Most industrial methods proceed from propene, which is processed via the intermediates allyl chloride and epichlorohydrin into glycerol. Another industrial method is hydroxylation of allyl alcohol with hydrogen peroxide in contact with WO₃, via the glycide stage.

Trimethylolpropane (TMP, Etriol, Ettriol, 1,1,1-tris(hydroxymethyl)propane) has the exact chemical designation 2-ethyl-2-hydroxymethyl-1,3-propanediol and is marketed in the form of colorless, hygroscopic masses having a melting point of 57-59° C. and a boiling point of 160° C. (7 hPa). It is soluble in water, alcohol, and acetone, but insoluble in aliphatic and aromatic hydrocarbons. It is manufactured by reacting formaldehyde with butyraldehyde in the presence of alkalis.

Pentaerythritol (2,2-bis(hydroxymethyl)-1,3-propanediol, Penta, PE) is a white crystalline powder with a sweetish taste that is non-hygroscopic and flammable and has a specific gravity of 1.399, a melting point of 262° C., and a boiling point of 276° C. (40 hPa). Pentaerythritol is readily soluble in boiling water, poorly soluble in alcohol, and insoluble in benzene, tetrachloromethane, ether, petroleum ether. Pentaerythritol is manufactured industrially by reacting formaldehyde with acetaldehyde in an aqueous solution of Ca(OH)₂ or NaOH at 15 to 45° C. A mixed aldol reaction first takes place, in which formaldehyde reacts as the carbonyl component and acetaldehyde as the methylene component. Because of the high carbonyl activity of formaldehyde, almost no reaction of acetaldehyde with itself occurs. Lastly, the tris(hydroxymethyl)acetaldehyde thus formed is converted into pentaerythritol and formate using formaldehyde in a cross Cannizzaro reaction.

Mono-, di-, and triglycerides are esters of fatty acids, by preference longer-chain fatty acids, with glycerol; depending on the glyceride type, one, two, or three OH groups of the glycerol are esterified. Possible acid components with which the glycerol can be esterified into mono-, di-, or triglycerides usable according to the present invention as plasticizers are, for example, hexanoic acid (caproic acid), heptanoic acid (oenanthic acid), octanoic acid (caprylic acid), nonanoic acid (pelargonic acid), decanoic acid (capric acid), undecanoic acid, etc. It is preferred in the context of the present compound to use fatty acids such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotinic acid), triacontanoic acid (melissic acid), as well as the unsaturated species 9c-hexadecenoic acid (palmitoleic acid), 6c-octadeceneoic acid (petroselinic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid), and 9c,12c,15c-octadecatrienoic acid (linolenic acid). For cost reasons, it is also possible to use natural fatty substances (triglycerides) directly, or the modified native fatty substances (partially hydrolyzed fats and oils). Alternatively, fatty acid mixtures can also be manufactured by cleavage of natural fats and oils and then separated, the purified fractions later being in turn converted into mono-, di-, or triglycerides. Acids that are esterified in this context with glycerol are, in particular, coconut oil fatty acid (approx. 6 wt % C₈, 6 wt % C₁₀, 48 wt % C₁₂, 18 wt % C₁₄, 10 wt % C₁₆, 2 wt % C₁₈, 8 wt % C_{18′}, 1 wt % C_{18″}), palm kernel oil fatty acid (approx. 4 wt % C₈, 5 wt % C₁₀, 50 wt % C₁₂, 15 wt % C₁₄, 7 wt % C₁₆, 2 wt % C₁₈, 15 wt % C_{18′}, 1 wt % C_{18″}), tallow fatty acid (approx. 3 wt % C₁₄, 26 wt % C₁₆, 2 wt % C_{16′}, 2 wt % C₁₇, 17 wt % C₁₈, 44 wt % C₁₈, 3 wt % C_{18″}, 1 wt % C_{18′″}), hardened tallow fatty acid (approx. 2 wt % C₁₄, 28 wt % C₁₆, 2 wt % C₁₇, 63 wt % C₁₈, 1 wt % C_{18′}), technical grade oleic acid (approx. 1 wt % C₁₂, 3 wt % C₁₄, 5 wt % C₁₆, 6 wt % C₁₆, 1 wt % C₁₇, 2 wt % C₁₈, 70 wt % C_{18′}, 10 wt % C_{18″}, 0.5 wt % C_{18′″}), technical grade palmitic/stearic acid (approx. 1 wt % C₁₂, 2 wt % C₁₄, 45 wt % C₁₆, 2 wt % C₁₇, 47 wt % C₁₈, 1 wt % C_{18′}), and soybean oil fatty acid (approx. 2 wt % C₁₄, 15 wt % C₁₆, 5 wt % C₁₈, 25 wt % C_{18′}, 45 wt % C_{18″}, 7 wt % C_{18′″}).

Surfactants, in particular nonionic surfactants, are also suitable as further plasticizers. The nonionic surfactants used are preferably alkoxylated, advantageously ethoxylated, in particular primary alcohols having by preference 8 to 18 carbon atoms and an average of 1 to 12 mol ethylene oxide (EO) per mol of alcohol, in which the alcohol radical can be linear or preferably methyl-branched in the 2- position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example, C₁₂₋₁₄ alcohols having 3 EO or 4 EO, C₉₋₁₁ alcohols having 7 EO, C₁₃₋₁₅ alcohols having 3 EO, 5 EO, 7 EO, or 8 EO, C₁₂₋₁₈ alcohols having 3 EO, 5 EO, or 7 EO, and mixtures thereof, such as mixtures of C₁₂₋₁₄ alcohol having 3 EO and C₁₂₋₁₈ alcohol having 5 EO. The degrees of ethoxylation indicated represent statistical averages that can be an integer or a fractional number for a specific product. Preferred alcohol ethoxylates exhibit a restricted distribution of homologs (narrow range ethoxylates, NRE). In addition to these nonionic surfactants, fatty alcohols having more than 12 EO can also be used. Examples of these are tallow fatty alcohol having 14 EO, 25 EO, 30 EO, or 40 EO.

It is particularly preferable to use, as plasticizers, nonionic surfactants that have a melting point above room temperature. Preferred shaped elements are consequently characterized in that nonionic surfactant(s) having a melting point above 20° C., by preference above 25° C., particularly preferably between 25 and 60° C., and in particular between 26.6 und 43.3° C., are used as plasticizers.

Suitable nonionic surfactants that exhibit melting or softening points in the aforesaid temperature range are, for example, low-foaming nonionic surfactants that can be solid or highly viscous at room temperature. When nonionic surfactants that are highly viscous at room temperature are used, it is preferred for them to exhibit a viscosity greater than 20 Pas, preferably greater than 35 Pas, and in particular greater than 40 Pas. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with structurally more complex surfactants such as polyoxypropylene/polyoxyethylene/polyoxypropylene (PO/EO/PO) surfactants.

In a preferred embodiment of the present invention, the nonionic surfactant having a melting point above room temperature is an ethoxylated nonionic surfactant that has resulted from the reaction of a monohydroxyalkanol or alkylphenol having 6 to 20 carbon atoms with preferably at least 12 mol, particularly preferably at least 15 mol, in particular at least 20 mol, of ethylene oxide per mol of alcohol or alkylphenol.

A nonionic surfactant that is solid at room temperature and is particularly preferred for use is obtained from a straight-chain fatty alcohol having 16 to 20 carbon atoms (C₁₆₋₂₀ alcohol), preferably a C₁₈ alcohol, and at least 12 mol, preferably at least 15 mol, and in particular at least 20 mol of ethylene oxide. Of these, the so-called “narrow range ethoxylates” (see above) are particularly preferred.

Accordingly, ethoxylated nonionic surfactant(s) that was/were obtained from C₆₋₂₀ monohydroxyalkanols or C₆₋₂₀ alkylphenols or C₁₆₋₂₀ fatty alcohols and more than 12 mol, preferably more than 15 mol, and in particular more than 20 mol ethylene oxide per mol of alcohol, is/are used in particularly preferred methods according to the present invention.

The nonionic surfactant preferably additionally possesses propylene oxide units in the molecule. Such PO units constitute by preference up to 25 wt %, particularly preferably up to 20 wt %, and in particular up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules constitutes by preference more than 30 wt %, particularly preferably more than 50 wt %, and in particular more than 70 wt % of the total molar weight of such nonionic surfactants.

Further nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene having 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Further preferred nonionic surfactants conform to the formula

R¹O[CH₂CH(CH₃)O]ₓ[CH₂CH₂O]_{y}[CH₂CH(OH)R²],

in which R¹ denotes a linear or branched aliphatic hydrocarbon radical having 4 to 18 carbon atoms, or mixtures thereof; R² a linear or branched hydrocarbon radical having 2 to 26 carbon atoms, or mixtures thereof: and x denotes values between 0.5 and 1.5 and y denotes a value of at least 15.

Further nonionic surfactants that are usable in preferred fashion are the end-capped poly(oxyalkylated) nonionic surfactants of the following formula:

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5. If the value of x≧2, each R³ in the formula above can be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³=H) or propylene oxide (R³=CH₃) units that can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred end-capped poly(oxyalkylated) alcohols of the above formula have values of k=1 and j=1, so that the formula above is simplified to

R¹O[CH₂CH(R³)O]ₓCH₂CH(OH)CH₂OR²

In the latter formula, R¹, R², and R³ are as defined above, and x denotes numbers from 1 to 30, preferably from 1 to 20, and in particular from 6 to 18. Surfactants in which the R¹ and R² radicals have 9 to 14 carbon atoms, R³ denotes H, and x assumes values from 6 to 15, are particularly preferred.

Further substances to be used in preferred fashion as plasticizers may be glycerol carbonate, propylene glycol, and propylene carbonate.

Glycerol carbonate is accessible by transesterifying ethylene carbonate or dimethyl carbonate with glycerol; ethylene glycil and methanol occur as byproducts. A further synthesis path proceeds from glycidol (2,3-epoxy-1-propanol), which is converted under pressure with CO₂, in the presence of catalysts, into glycerol carbonate. Glycerol carbonate is a clear, low-viscosity liquid with a specific gravity of 1.398 gcm⁻³ that boils at 125-130° C. (0.15 mbar).

Two isomers of propylene glycol exist: 1,3-propanediol and 1,2-propanediol. 1,3-Propanediol (trimethylene glycol) is a neutral, colorless, odorless, sweet-tasting liquid of specific gravity 1.0597 that solidifies at −32° C. and boils at 214° C., 1,3-Propanediol is manufactured from acrolein and water with subsequent catalytic hydrogenation.

Far more important industrially is 1,2-propanediol (propylene glycol), which is a oily, colorless, almost odorless liquid exhibiting a specific gravity of 1.0381, which solidifies at −60° C. and boils at 188° C. 1,2-Propanediol is manufactured from propylene oxide by addition of water.

Propylene carbonate is a water-clear, low-viscosity liquid having a specific gravity of 1.21 gcm⁻³; the melting point is −49° C. and the boiling point is 242° C. Propylene carbonate is also accessible on an industrial scale by reacting propylene oxide and CO₂ at 200° C. and 80 bar.

Additional additives that are suitable, which by preference exist in solid form at room temperature, are, in particular, highly dispersed silicic acids. Good choices here are pyrogenic silicic acids such as commercially usual Aerosil®, or precipitated silicic acids. Particularly preferred methods according to the present invention are characterized in that one or more materials from the group of (by preference, highly dispersed) silicic acid, dispersion powders, high-molecular-weight polyglycols, stearic acid and/or stearic acid salts, and/or from the group of the inorganic salts such as sodium sulfate, calcium chloride, and/or from the group of the inclusion formers such as urea, cyclodextrin, and/or from the group of the superabsorbers such as (by preference, crosslinked) polyacrylic acid and/or salts thereof such as Cabloc 5066/CTF, and mixtures thereof, is/are used as further additives.

Shaped elements preferred according to the present invention can contain dyes. Suitable dyes possess excellent shelf stability and insensitivity to the other ingredients of the agents and to light, and no pronounced substantivity with respect to the substrates that come at least into direct contact with the dye-containing agents, such as textiles, glass, ceramic, or plastic dishes, in order not to color them.

In selecting the coloring agent, care must be taken that the coloring agents exhibit excellent shelf stability and insensitivity to light. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the shaped elements varies as a function of solubility and thus also of oxidation sensitivity. For readily water-soluble coloring agents, coloring-agent concentrations in the range of a few 10⁻² to 10⁻³ wt %, based on the entire shaped element, are typically selected. In the case of the pigment dyes, on the other hand, which are particularly preferred because of their brilliance but are less readily water-soluble, the appropriate concentration of the coloring agent is typically a few 10⁻³ to 10⁻⁴ wt %, based on the entire shaped element.

Preference is given, by preference, to those coloring agents that can be oxidatively destroyed in a washing process, as well as mixtures thereof with suitable blue dyes, so-called bluing agents. It has proven advantageous to use coloring agents that are soluble in water or at room temperature in liquid organic substances. Anionic coloring agents, e.g. anionic nitroso dyes, are suitable, for example.

Suitable as optical brighteners, which can be contained by preference in shaped elements according to the present invention, are, for example, 1,3,5-triazinyl derivatives of 4,4′-diamino-2,2′-stilbenedisulfonic acid (flavonic acid), 4,4′-distyrylbiphenylene, hymecromon (methylumbelliferone), cumarin, dihydroquinolinone, 1,3-diarylpyrazoline, naphthalic acid imide, benzoxazole systems linked via CH═CH bonds, benzisoxazole and benzimidazole systems, and pyrene derivatives substituted with heterocycles.

The shaped elements according to the present invention, in particular the foils (films) according to the present invention, are not packaging material for liquids or solids, washing-agent pouches, or the like.

According to a preferred embodiment the shaped element carries on one surface an adhesive layer that is, by preference, water-dispersible or water-soluble, the adhesive layer comprising a polymerizate that is adhesive at room temperature under pressure and/or in the presence of moisture. It is particularly preferred in this context that a substance having cleaning ability be contained in the adhesive layer, that substance preferably being dispersed in the polymerizate.

According to a preferred embodiment, the washing- or cleaning-agent constituents contained in the adhesive layer are present by preference as viscous liquids, in particular as a gel, and/or as solid particles; in particular, daylight-active bleaching agent, by preference based on TiO₂, is contained. If the washing- or cleaning-agent constituents are, by preference, in a viscous state, they can ensure a desired tackiness between the substrate surface and the shaped element, so as thereby to assist adhesion of the shaped element on the spot.

A suitable viscous liquid such as, for example, a paste, a gel, or a solution can by preference have a viscosity from approximately 200 to approximately 1,000,000 cps at low shear rates (less than 1/s). The viscosity can preferably be approximately 100,000 to approximately 800,000 cps, and more preferably approximately 400,000 to approximately 600,000.

A suitable gel can be constituted from known gelling agents. The gelling agent can be, for example, a swellable polymer. Suitable gelling agents for use in the context of the present invention can be, for example, carboxypolymethylene, carboxymethyl cellulose, carboxypropyl cellulose, poloxamer, carrageenan, Veegum, carboxyvinyl polymers, and natural gums such as karaya gum, xanthan gum, guar gum, gum arabic, tragacanth gum, and mixtures thereof. Suitable gel compositions by preference also contain water, for example in quantities from 0.1% to 95%, based on the entire gel composition.

A pH regulator can also, for example, be added to the gel. Suitable materials include, for example, sodium bicarbonate, sodium phosphate, sodium hydroxide, ammonium hydroxide, sodium stannate, triethanolamine, citric acid, hydrochloric acid, sodium citrate, and combinations thereof. The pH regulators can be added in a quantity such that they adjust the pH of the gel composition, for example, to 3 to approximately 12, by preference to approximately 4 to 10, in particular to approximately 5 to 9. The pH regulators can be present, for example, in a quantity from approximately 0.01% to approximately 15%, and by preference from approximately 0.05% to approximately 5%, of the substance weight.

A suitable gel can already exhibit sufficient adhesive power by itself, but additional gelling agents or adhesive agents that can intensify adhesion to the textile can nevertheless be included.

If the shaped element according to the present invention carries a tacky layer, by preference an adhesive layer, this (adhesive) layer is by preference equipped with a solid, pull-off protective film; this corresponds to a preferred embodiment.

In a preferred embodiment, a suitable shaped element is less than 3000 μm thick, advantageously less than 2000 μm thick, in particular less than 1000 μm thick. The thickness of a suitable shaped element can be, for example, approximately 500 to 900 μm; it can also be less than 500 μm, for example between 5 and 450 μm.

Preferred film thicknesses are equivalent, in particular, to values of, for example, <400 μm, <300 μm, <200 μm, or even less than <100 μm. Thicknesses of, for example, <80 μm, <60 μm, or <40 μm are also possible.

Possible minimum thicknesses can be equivalent, for example, to values such as, for example, 2, 3, 4, 5, 6, 7, 8, 9, or 10 μm. Minimum thicknesses of, for example, 15, 20, 25, 30, 35, 40, 45, or 50 μm are also possible; values of at least 60, 70, 80, 90, 100, 150, or 200 μm are in fact possible.

A film according to the present invention can thus have, for example, a thickness from 3 to <200 μm or, for example, from 20 to <80 μm, to mention only two examples.

The length-width dimensions of a preferred strip-shaped, sheet-shaped, disk-shaped, or web-shaped shaped element such as, in particular, a film or foil can equal (mutually independently):
a) lengthwise, by preference 1 cm to 30 cm, advantageously 2 cm to 20 cm, with additional advantage 3 cm to 15 cm, in particular 4 cm to 10 cm,
b) widthwise, by preference 1 cm to 25 cm, advantageously 2 cm to 20 cm, with further advantage 3 cm to 15 cm, in particular 4 cm to 10 cm.

The minimum length of the film can also be 5, 6, 7, or 8 cm. The minimum width of the film can likewise be 5, 6, 7, or 8 cm.

The film can be, for example, rectangular, square, round, or oval. It can also have any other shape, e.g. heart-shaped, number-shaped, or letter-shaped.

The shaped element can be manufactured using all known methods. For example, a film according to the present invention can be manufactured using a variety of the known methods for film manufacture. A film can by preference be manufactured using a blowing or casting method. Methods such as extrusion and other methods are likewise possible.

According to a further preferred embodiment, the withdrawal receptacle is a flexible or inflexible, advantageously reclosable receptacle at least partly enclosing the shaped element, by preference a box, pouch, or envelope; in particular, it is a dosing dispenser. A dosing dispenser permits single-portion withdrawal of the shaped element, preferably of a film.

The receptacle can be designed so that only one individual shaped element is enclosed by the receptacle. The receptacle can also be designed so that it encloses multiple shaped elements. Lastly, the receptacle can also be designed so that it encloses multiple shaped elements, the individual shaped elements in turn being individually enclosed by other receptacles. The fact that a receptacle “encloses” a shaped element means, in the context of this invention, that the receptacle at least partly, but in particular completely, surrounds the shaped element.

The withdrawal receptacle can be any receptacle that is suitable for at least partly encasing and/or holding together a film-shaped shaped element.

The receptacle can be constituted from a flexible, semirigid, or dimensionally stable material.

A dimensionally stable receptacle has the advantage of protecting, in particular, fragile film-shaped shaped elements from mechanical influences, and preventing corresponding damage.

In order to prevent swelling or unintentional activation of the film-shaped shaped elements, the receptacle is preferably embodied in water-vapor-tight fashion.

In order to prevent unintentional emission of substances such as, for example, fragrances, from the film-shaped shaped elements, the receptacle is preferably embodied in fragrance-tight fashion.

In a further, preferred embodiment of the invention, means for child-safe opening are provided on the receptacle in order to prevent unintentional contact by children with the film-shaped shaped elements.

In particular, dosing and withdrawal aids for the film-shaped shaped elements are provided on the container according to the present invention.

A flexible container can be, for example, a packaging pouch such as, for example, a flat pouch, sealed-edge pouch, stand-up pouch, double pouch, open pouch, or tubular pouch, e.g. a pouch made of a multi-layer, film-shaped, flexible composite material, the pouch by preference having an easy-open feature such as, for example, a tear strip or a tear-open notch.

It is conceivable to arrange the film-shaped shaped elements individually or in a plurality in a flexible container.

The film-shaped shaped elements packaged in one or more flexible containers can be provided for use in tape or sheet dispensers.

The withdrawal receptacle can also encompass a roll or be made up thereof. The strip-shaped, sheet-shaped, disk-shaped, or web-shaped flexible shaped elements can thus be wound onto a roll, the shaped element by preference being provided with separation points for single-portion withdrawal. Withdrawal receptacles of this kind are known, for example, from the field of adhesive-tape rollers. Adhesive-tape rollers fall under the general term of tape dispensers. All tape dispensers can be suitable as a withdrawal receptacle.

A preferred embodiment thus exists if the withdrawal receptacle comprises a roll, by preference is a tape dispenser, the shaped element being provided in particular with separation points for single-portion withdrawal.

Also useful for producing tape pieces are apparatuses, called tape applicators, with which the tape is unwound from a roll and guided over a cutting element. When the free end of the tape has reached the desired length, it is cut off with the cutting element. In these apparatuses, the length of the tape to be cut off is determined by the user by unrolling the tape to the desired length and then cutting it off. To cut it off, he or she must guide the end of the tape over the cutting element, typically a cutting blade having saw-like teeth made of either metal or plastic, in such a way that it can act in cutting fashion on the tape. Such, or similar, tape dispensers are usable with advantage according to the present invention.

Refillable tape dispensers for repeatable reception of a tape roll are particularly preferred.

Also particularly suitable, for example, are those tape dispensers known from the field of correction tape dispensers (film transfer rollers). If the withdrawal receptacle according to the present invention is a film transfer roller, this is then a preferred embodiment.

In corresponding tape dispensers, supply and takeup spools that rotate about parallel axes are present inside a housing, the supply spool being connected to the takeup spool via a friction clutch. The housing can be designed so that it is held directly in the user's hand, or it can form a cartridge that is inserted into a reusable outer housing. A segment of the tape extending between the spools is guided out of the housing and around a tip that has a relatively sharp edge, which is used to press the tape against the surface onto which the strip having a washing- or cleaning-agent ingredient is to be applied. The tape is made up of a carrier tape, made e.g. of plastic or paper, one of whose sides has a coating of a mixture containing washing- or cleaning-agent ingredient, this coating being the outer side of the carrier tape When it is guided around the tip. The dispenser is held in the hand during use, and the tip is pressed against the surface in such a way that its edge presses the tape against the surface along the entire tape width.

The mixture containing washing- or cleaning-agent ingredient has an adhesive property and it has a greater ability to adhere to the textile than to its carrier tape, so that when the tip is displaced transversely over the textile surface in a direction that is perpendicular to the edge of the tip, the tip slides with respect to the carrier tape, with the result that tape is pulled off the supply spool. The resulting rotation of the supply spool also rotates the takeup spool, so that a substantially constant tension is maintained in the tape, and the takeup spool winds on the used tape over which the tip has passed and from which the coating made of a mixture containing washing- or cleaning-agent ingredient has been deposited onto the textile surface. A continuous strip of the mixture containing washing- or cleaning-agent ingredient is thereby placed onto the textile, this strip having a length that corresponds to the distance over which the dispenser tip was displaced.

This principle is advantageously applicable to the present invention. What is involved here is a washing- or cleaning-agent tape dispenser with which a washing- or cleaning-agent mixture can be applied in film-like fashion onto a surface. The mixture containing washing or cleaning agent on the carrier tape is, in this case, the shaped element according to the present invention.

A film transfer roller for transferring onto textile a washing or cleaning agent applied in the form of a film onto a carrier tape is a subject preferred according to the present invention. Transfer rollers serve for transfer of a film from a carrier film onto a substrate. These apparatuses have in common the fact that upon pressure contact between the applicator head of the apparatus and the substrate, a film is transferred onto the substrate, and the carrier film released from the film is wound onto the takeup spool.

Also useful are receptacles for outputting sheets or strips. These are apparatuses that contain a stack of sheets, strips, or films, etc., and encompass a dosing or withdrawal aid for the sheets, strips, or films.

This stack is preferably arranged so that upon withdrawal of the uppermost sheet, the sheet located therebeneath is aligned so that it is subsequently withdrawable without difficulty. For example, in the case of such apparatuses having a withdrawal slot, upon withdrawal of the uppermost sheet the following sheet is already carried along sufficiently that it then already projects out of the withdrawal slot and can easily be withdrawn.

This refers, for example, to a block of films that each comprise a layer made of a flexible polymer material that can be equipped, on a second end region, with a coating made of repositionable self-stick material, while along a visually recognizable first end region they are, at least in a stack, fee of adhesive, the adjacent ends of the sheets being aligned toward one another and the first and the second ends of successive sheets being arranged adjacently. The stack can be arranged in a chamber that is partly delimited in the upper wall by a slot through which the first end region of the uppermost sheet projects. By relative motion between the upper wall and the uppermost sheet alignment of the slot with following regions of the sheet as far as its second end is achieved when the uppermost sheet is pulled through the slot, while those successive regions are being pulled off the stack. The end region of the sheet located therebeneath is moved through the slot along with the end region of the uppermost sheet, so as thereby to allow the first end region of the sheet located therebeneath to project out of the slot when the uppermost sheet is removed. Such, or similar, sheet withdrawal systems are preferred according to the present invention.

Upon utilization of the present invention, according to the present invention a foil or film can be applied by the consumer directly onto the spot-stained substrate.

It is likewise possible to used a shaped element according to the present invention, such as preferably a film, for preparation of a washing bath. Shaped elements according to the present invention can be used successfully, in particular, in conjunction with textile laundering in an automatic washing machine. A shaped element according to the present invention can contain, for example, post-treatment and/or care-providing components.

A further subject of this invention is therefore a method for producing an aqueous system having cleaning ability and/or care-providing ability, in which at least a portion of the contained shaped element is withdrawn from the washing- or cleaning-agent delivery system according to the present invention and is added to an aqueous system. The aqueous system having cleaning and/or care-providing ability is advantageously a washing bath for textile, dish, body, floor, or window cleaning.

The portioning according to the present invention of a washing or cleaning agent into shaped elements according to the present invention enables individual dosing of non-liquid washing or cleaning agents, which dosing the consumer can control, for example, by way of the number of films to be used.

A further subject of the invention is therefore the use of a washing- or cleaning-agent delivery system for individual dosing of non-liquid washing or cleaning agents. The shaped elements according to the present invention can, in the context of use in conjunction with textile laundering in an automatic washing machine, be added through the bleach dispenser of the washing-machine drawer, or placed directly with the laundry in the washing drum.

A further subject of the invention is a method for local spot treatment of substrates, in particular textiles or hard surfaces, in which a shaped element is withdrawn from the washing- or cleaning-agent delivery system according to the present invention and applied directly onto the spot to be treated, by preference applied in adhering fashion, for example with the aid of a transfer roller.

“Spot treatment” is understood in this context as all treatments that cause the spot intensity of the spot to be treated to diminish, i.e. cause the spot to become less perceptible and thus less obtrusive to the viewer. Ideally, the spot is completely removed by the treatment. “Local” means in this context that the spot-stained material, e.g. textile, need not be subjected in its entirety to a cleaning process, for example in a washing machine, but instead that only the individual spot (i.e. the spot-stained region) is treated in locally delimited fashion. This procedure is particular economical of material, since only the actual stained regions are subjected to cleaning.

According to a preferred embodiment, this method is particularly suitable for spot treatment of greasy and/or colored stains, the stains by preference comprising
anthocyanins,
betalains, by preference betacyanins, betaxanthins, betanin, betanidine,
carotenoids, by preference carotenes, xanthophylls,
chlorophyll,
anthranoids,
quinones,
flavonoids,
curcuma dyes,
hemoglobin,
brown tannins from tea, fruit, red wine,
brown humic acids from coffee, tea, cocoa, and/or
industrial dyes, by preference from cosmetics, colored pens, inks.

According to a preferred embodiment, the spot to be treated and/or the shaped element are moistened before application of the shaped element onto the spot. Moistening results in adhesion upon application of the shaped element onto the substrate to be treated.

For example, water-soluble or water-dispersible films that are pressed onto a moistened spot develop a certain tackiness upon contact with the moist textile, since the film material is partially dissolved by the moisture. The partially dissolved film can thus adhere to the spot or, depending on how much the spot was moistened, can later move entirely into the spot-stained textile and release therein the active substances that are contained.

The desired adhesion effect can also come from an adhesive that is optionally applied on the shaped element, by preference a film. Adhesives activatable by moisture, for example, are preferred for use. Corresponding adhesive substances are known, for example, from postage stamps or mailing envelopes. Pressure-sensitive, by preference removable adhesive substances can, however, also be involved. Such adhesive substances are known, for example, from adhesive notes that can easily be stuck onto a surface and removed from it again without difficulty.

According to a preferred embodiment of the method, the shaped element is pulled off again from the textile (i.e. the spot) after a contact time of, for example, at least 30 seconds. The contact time can also be longer, for example ≧1 minute, ≧2 minutes, ≧3 minutes, ≧4 minutes, or ≧5 minutes. According to another preferred embodiment, the film can also be left on the surface.

In a preferred embodiment of the method, after application of the spot/film and implementation of a contact time, the spot-stained textile is treated with water, for example by local rubbing with a moist cloth, in particular by subjecting the textile to a manual or automatic textile washing procedure.

If it is intended for spot treatment, the shaped element according to the present invention preferably possesses a size such that it completely covers the spot to be treated. The handling here can be analogous to that of a wart patch, which is cut to the size of the wart area and then stuck onto the wart. The shaped element according to the present invention can thus be cut to size. In the context of a preferred method, a shaped element is thus cut to the size of the spot and then applied onto the spot to be treated.

A washing- or cleaning-agent patch that comprises a nonwoven mat and a patch compound that comprises, in addition to adhesive constituents, at least one substance having a cleaning effect, the patch compound covering an entire surface side of the nonwoven mat, is a shaped element preferred according to the present invention. According to a particular embodiment, on the other hand, the shaped element is not a patch.

For manufacture of a washing- or cleaning-agent patch of this kind, for example, a variety of constituents such as, for example, resins, polymers, etc. can be melted together with one another under the action of heat and applied, while still warm, onto the nonwoven mat. A substance having a cleaning effect can be added to the melt, for example, before or after application onto the nonwoven mat.

The shaped element, by preference a film, can by preference be made of a soft, deformable material that can adapt to the substrate surface to be treated. The shaped element is advantageously easily adaptable to the shape of the substrate surface, at least after moistening of the spot and/or of the shaped element.

The shaped element according to the present invention is by preference transparent, so that it is unobtrusive after application onto the surface to be cleaning and is perceptible only upon closer examination.

As has already been stated, a shaped element according to the present invention contains at least one substance having a cleaning effect. Suitable substances include, in particular, all materials that provide a bleaching effect or provide spot removal or spot mitigation.

Suitable substances are all surfactants, in particular anionic, nonionic, cationic, and/or amphoteric surfactants. Suitable substances are all bleaching agents, e.g. peroxides, metal chlorites, perborates, percarbonates, peroxygen acids. Suitable peroxide compounds are, for example, hydrogen peroxide, calcium peroxide, carbamide peroxide. Suitable metal chlorites are, for example, calcium chlorite, barium chlorite, magnesium chlorite, lithium chlorite, sodium chloride, and potassium chlorite. Hypochlorite and chlorine dioxide can also be suitable. A preferred chlorite is sodium chlorite.

As already stated, a shaped element according to the present invention can by preference contain adhesive substances, in particular in a layer that is applied onto the shaped element.

Suitable adhesive substances can, for example, exhibit limited water solubility. Such adhesive substances can contain, for example, hydroxyethyl- or propyl celluloses. By preference, suitable adhesive substances can also contain polyvinylpyrrolidone, by preference having a molecular weight from approximately 50,000 to approximately 300,000.

An adhesive substance that is suitable, for example, for use in the present invention can advantageously encompass a combination of copolymers of methyl vinyl ether and maleic acid anhydride and the polymer carboxymethyl cellulose.

A suitable adhesive substance can also, for example, encompass phthalate resins, polyvinyl ether dispersions, and acrylate mixed polymer; for example, a suitable adhesive can be made up of 5 to 25 wt % phthalate resin, 25 to 45 wt % polyvinyl ether dispersions, and 35 to 55 wt % acrylate mixed polymer (wt % based on the adhesive).

Also particularly suitable are all viscoelastic adhesive substances, in particular those that are permanently tacky and capable of adhesion at 20° C. and, with low substrate specificity, immediately adhere with light contact pressure onto almost all substrates, in particular textile.

Polymers contained in preferred adhesive substances are, for example, natural and synthetic rubbers, polyacrylates, polyesters, polychloroprenes, polyisobutenes, polyvinyl ethers, and polyurethanes. These can be used by preference in combination with additives such as resins, plasticizers, and/or antioxidants.

Suitable adhesives are, in particular, all those rubber materials and/or synthetic resins, homo- or copolymerizates that adhere well upon application of pressure. Polymerizates having a glass transition temperature from −10 to −70° C. are, for example, suitable as adhesives.

Non-limiting examples of suitable polymerizates that adhere at room temperature upon application of pressure encompass, for example, styrene/isoprene/styrene block copolymers, styrene/butadiene rubber, polybutene rubber, polyisoprene rubber, butyl rubber, silicone rubber, natural rubber, synthetic isoprene rubber, synthetic resins such as poly(meth)acrylate, polyvinyl ether, PUR, polyester, polyamide, ethylene copolymers.

Preferred adhesives encompass acrylate copolymerizates that encompass at least 50% acrylic or methacrylic acid alkyl esters and vinyl ester monomers. Examples of suitable monomers are n-butyl acrylate or methacrylate, hexyl acrylate, 2-ethylbutyl acrylate, isooctyl acrylate, 2-ethylhexyl acrylate or methacrylate, nonyl acrylate, acrylic or methacrylic acid, itaconic acid, maleic acid, maleic acid anhydride, hydroxyethyl acrylate, acrylamide, acrylonitrile, vinylpyrrolidone, vinylimidazole, vinyl acetate, vinyl propionate.

Particularly preferred in very general terms are any adhesive substances for adhesive joins in which a later manual separation is possible without damage to the adhesively bonded object, and which do not make excessive demands in terms of strength but instead correspond, for example, to the adhesive effect of adhesive bandages, adhesive notes, masking tapes, adhesive tapes and films, or self-adhesive labels.

The coating of the shaped element can also contain an additional carrier material. Suitable carrier materials can encompass, for example, humectants. Suitable humectants are, for example, glycerol, sorbitol, polyethylene glycol, propylene glycol, and other polyvalent alcohols.

Humectants can be present, for example, in a quantity from approximately 10% to approximately 95%, by preference from approximately 20% to approximately 80%, and in particular from approximately 50% to approximately 70% of the weight of the coating.

In addition to the aforesaid materials, the coating can encompass further materials, for example odorants, opacifiers, coloring agents, and complexing agents such as, for example, ethylenediaminetetraacetic acid.

In the case of a coated shaped element, it is also possible for a separating layer to be provided between the coating and the actual shaped element. The separating layer is a protective or covering layer that is substantially impermeable to the active substance. A suitable separating layer can encompass, by preference, a stiff flat material such as polyethylene, paper, polyester, or another material, which in turn can be coated with a non-adhering material type such as, for example, wax, silicone, polyester such as Teflon®, fluoropolymers, or other non-adhering materials.

Be it noted at this juncture that the shaped element according to the present invention is not a so-called moist wipe as known, for example, from the sector of eyeglass cleaning wipes, body hygiene wipes, or also moist towelettes.

As already stated, a shaped element according to the present invention can by preference be coated. A coating can be manufactured in any manner, for example by brushing, spraying, or immersing the shaped element.

In a preferred variant, in order to manufacture a coating solution a polymerizate that adheres at room temperature upon application of pressure, and if applicable further substances, are dissolved in a solvent. This coating solution is applied onto the surface of the shaped element and the coating solution is then dried. If further active substances were added during manufacture of the coating solution, that quantity of active substance that exceeds the quantity dissolved in the polymerizate in the saturated state then crystallizes upon drying, and is present in the polymerizate in the form of dispersed (finely) crystalline particles. This is particularly suitable with regard to TiO₂. A suitable coating, in particular an adhesive coating, can also encompass fillers such as SiO₂ powder, CaCO₃, or carriers such as cyclodextrin or cellulose powder.

As has already been made evident, the shaped element according to the present invention is by preference a foil or a film. Film manufacture can be accomplished using all known methods.

Film manufacture via thermoplastic processing by calendering or extrusion is the most preferred. Coextrusion is particularly preferred.

The blown film method and flat film method are, according to the present invention, very preferred methods for film manufacture. The manufacture of blown films is known. For example, firstly a mixing of polymer material such as, for example, PVOH powder with additives and stabilizers in the solid state is performed. This mixture is melted in a heated extruder. Further ingredients can be added, for example, to the melt. This is followed by blowing of the melt, cooling, and spooling of the film.

Blown films can generally be manufactured more economically than cast films, but the film thickness distribution can fluctuate somewhat more and in some cases more air inclusions can occur. As a rule, blown films are somewhat harder and have lesser rebound properties than cast films, whereas the latter can be soft, flexible, or even almost rubbery, and can also exhibit a substantial rebound tendency.

When films are manufactured from solutions of polymers, these are referred to as casting methods. The polymer solutions can be manufactured, according to the present invention, by the use of solvents (which is preferred), or by chemical conversion of insoluble macromolecules into soluble derivatives. Further ingredients that may be required can be added, for example, to the polymer solution. There are several methods for converting the polymer solutions into films. When the polymer solution is precipitated in a bath, these are referred to as wet-casting methods. In cellophane manufacture, for example, a highly viscous cellulose solution is pressed through a wide slit nozzle into a highly acid precipitation bath. When the solvent is evaporated and the polymer is thereby obtained as a film, these are referred to as dry casting methods; strip or drum casting machines can be used to carry them out.

In the strip casting method (also called the chill roll method), which is usable in preferred fashion according to the present invention, the polymer solution, which according to the present invention can if applicable contain further ingredients, is cast from a reservoir, preferably through a nozzle, onto an endless, by preference highly polished, metal strip. The strip speeds depend greatly on the material used and on the desired film thickness. They can be, by preference, between 2 and 60 meters per minute. The film can be pulled off after evaporation of most of the solvents. For spooling, it is preferably passed through a dryer with hot recirculating air, or over heated rollers. Resulting film thicknesses with this method can be, by preference, 15 to 300 pm. It is possible and preferred for the polymer solution, before it is cast onto the metal strip, first to be forced through a filter in order to retain undissolved particles that might otherwise cause clumping. It is likewise possible and preferred to remove at least a portion of the air contained in the polymer solution in a degassing container, before casting onto the metal plate.

For the manufacture of films such as, for example, PVOH films using the casting method, the PVOH powder/granulate and plasticizer (e.g. PEG and/or glycerol) are therefore, for example, dissolved in water in a formulation container. The solution is then delivered into a reservoir. The solution is then heated to approx. 80° C. and then delivered via a slit nozzle onto a strip roller. In the drying process (hot-air conduit), the solution becomes a film. According to the present invention, perfume oils can be added to the PVOH mixture, for example, in the formulation container.

The drum casting method is similar to the strip casting method. In the former, heated drums (having diameters of approx. 2 to 3 meters and widths of approximately 2 meters) are used instead of the metal strip.

The casting method yields films that usually exhibit a consistently uniform film thickness distribution and few air inclusions; the method is, however, expensive because of the energy-intensive drying. Thinner films can be manufactured with the casting method than with the blowing method.

The casting method is by preference utilized for those substances that cannot be melted or that decompose when melted, e.g. cellulose or polyimide. The casting method is likewise preferred for use for the manufacture of very thin films.

Roller or sintering methods are also possible in principle for film manufacture, but are advisable only in exceptional cases, e.g. for the manufacture of tetrafluoroethylene films and polyimide films.

Also possible, for example, is a method for the manufacture of a film such that firstly, by dissolution or dispersal of one or more polymers in a liquid carrier medium, a rollable preparation is manufactured, and the latter is then converted into film form by rolling with the aid of a roller apparatus. The liquid carrier medium can be evaporated simultaneously or subsequently in this context.

A liquid carrier medium comprises, by preference, solvents or dispersing agents such as water, alcohols, ethers, or hydrocarbons, or mixtures of two or more of the aforesaid substances, the substances or substance mixtures being liquid at room temperature (20° C.). Suitable alcohols are, for example, the mono- or polyvalent alcohols having 1 to 5 carbon atoms such as, for example, ethanol, isopropanol, ethylene glycol, glycerol, and propylene glycols.

The concentration of liquid carrier medium in the rollable preparation can be, for example, in the range from 20 to 90 wt % or 30 to 70 wt %.

A suitable rollable preparation can have, for example, a semisolid or doughy consistency or can be a viscous liquid with which a suitable carrier can be coated and with which, by rolling with a roller apparatus, the desired film thickness can be produced. The finished film is then removed from the carrier after drying. Suitable carrier materials can be selected, for example, from the group of silicone, metal, metallized polymers, polytetrafluoroethylene, polyether/polyamide block copolymers, polyurethanes, polyvinyl chloride, nylon, alkylene/styrene copolymers, polyethylene, polyester, or other releasable materials.

Suitable roller apparatuses are, for example, the known so-called forward roll or reverse roll coaters equipped with at least two co- or counter-rotating rolls or rollers, a reverse roll method being preferred.

The films resulting from any possible method can subsequently be further processed, for example by vacuum deposition, coating, imprinting, or flock coating.

In a preferred embodiment of the inventions, the films according to the present invention are foamed films. In order to obtain foamed films, gas bubbles of a suitable gas such as, for example, air are enclosed in the films. Such films having enclosed gas bubbles are notable for particularly good haptic properties. In addition, they can exhibit improved water solubility. Preferred films such as, in particular, foamed films have a density of <1 kg/m³.

A number of possibilities are available for incorporating the gas bubbles. For example, a blowing agent or propellant can be used. Foaming can be achieved, for example, by mechanical agitation of the carrier mass while still liquid or viscous. A gas-generating chemical reaction can, for example, be provoked. It is possible, for example, to use a highly volatile solvent that is evaporated at elevated temperatures. Introduction of a gas or a liquefied gas into the still-viscous carrier mass can, for example, be accomplished.

It maybe preferred, however, to use blowing agents. These are substances that decompose when heated and evolve gas so that, for example, nitrogen or carbon dioxide is released.

Carbonates, hydrogencarbonates, boron hydrides, silicon oxyhydrides, etc. are examples of suitable inorganic blowing agents. Also usable by preference, however, are all organic blowing agents such as those used, in known fashion, in the manufacture of porous or bubble-containing plastics.

Films according to the present invention such as, by preference, foamed films, can also be present in confetti form. “Confetti form” refers to a plurality of film shreds or film scraps or small pieces of film. “Confetti” is known in general conversation as a term for small, brightly colored paper shreds. Films in confetti form need not necessarily be as small as known paper confetti, which is thrown into the air especially during Mardi Gras parades but also on other occasions such as children's birthdays or weddings. The confetti form can be regular or irregular; it can involve, for example, circular film shreds and can involve, for example, heart-shaped film shreds. Any conceivable shape is possible and obtainable, for example, by stamping the film confetti out of a larger parent film. The use of films according to the present invention in confetti form can be advantageous, for example, in hand textile laundering, when a specific quantity of films in confetti form is scattered into the textile treatment bath.

The resulting shaped elements, by preference films, resulting from all possible manufacturing methods can subsequently be further processed, for example by vacuum deposition, coating, imprinting, or flock coating.

A shaped element according to the present invention can, by preference, also encompass odorants (perfume).

According to a preferred embodiment, the shaped element according to the present invention contains at least 0.05 wt % perfume, by preference at least 0.1 wt % perfume, in particular at least 0.5 wt % perfume, based on the entire shaped element. The shaped element can likewise also contain even larger quantities of perfume, for example at least 1, 2, 4, 6, 8, or even at least 15 wt % perfume. Useful upper limits for perfume can be, for example. 10 wt %, 9 wt %, 8 wt %, 7 wt %, 6 wt %, 5 wt %, 4 wt %, 3 wt %, 3 or even 1 wt %.

In the technical field of fragrances, certain materials having no odor or a very weak odor are used as dilution agents or extending agents for perfumes. Non-limiting examples of these materials are dipropylene glycol, diethyl phthalate, triethyl citrate, isopropyl myristate, and benzyl benzoate. These materials are used, for example, to dilute and stabilize certain other fragrance constituents. These materials are not included in the calculation of the total quantity of odorants contained in the shaped element.

According to a preferred embodiment, the shaped element according to the present invention contains odorant precursors that preferably release odorants, by hydrolysis, only in the presence of H₂O. The odorant precursors can advantageously be selected from β-aminoketone odorant precursors, aldehyde- or ketone-releasing odorant precursors, alcohol-releasing odorant precursors, by preference silicic acid esters, and orthocarbonate and orthoester odorant precursors. Advantageously, the odorant precursors are selected from acetals, ketals, orthoesters, orthocarbonates, and mixtures thereof.

Possible other constituents that can be contained in the shaped elements according to the present invention are advantageously selected from the group of the detergency builders, bleaching agents, surfactants, optical brighteners, bleach activators, enzymes, electrolytes, nonaqueous solvents, pH adjusting agents, fluorescing agents, dyes, hydrotopes, foam inhibitors, silicone oils, anti-redeposition agents, graying inhibitors, shrinkage preventers, crease prevention agents, color transfer inhibitors, antimicrobial active substances, germicides, fungicides, antioxidants, corrosion inhibitors, antistatic agents, ironing adjuvants, proofing and impregnation agents, swelling and anti-slip agents, and UV absorbers.

Surfactants are contained in the shaped elements according to the present invention by preference in quantities of ≧0,1 wt %, ≧1 wt %, ≧3 wt %, ≧5 wt %, ≧10 wt %, ≧15 wt %, ≧20 wt %, in particular ≦25 wt % (wt % based on the entire shaped element. A suitable upper limit for surfactants contained in the shaped element according to the present invention can be, for example, 40 wt %, 30 wt %, 20 wt %, 15 wt %, 10 wt %, or 5 wt %. According to a less-preferred embodiment, the shaped element according to the present invention contains no surfactants.

Bleaching agents and/or bleach activators are contained in the shaped elements according to the present invention by preference in quantities of ≧0,1 wt %, ≧1 wt %, ≧3 wt %, ≧5 wt %, ≧10 wt %, ≧15 wt %, ≧20 wt %, in particular ≦25 wt % (wt % based on the entire shaped element). A suitable upper limit for bleaching agents and/or bleach activators contained in the shaped element according to the present invention can be, by preference, 40 wt %, 30 wt %, 20 wt %, 15 wt %, 10 wt %, or 5 wt %. According to a less-preferred embodiment, the shaped element according to the present invention contains no bleaching agents and/or bleach activators.

Detergency builders are contained advantageously in quantities of ≦15 wt %, ≦10 wt %, ≦9 wt %, ≦8 wt %, ≦7 wt %, ≦6 wt %, ≦5 wt %, ≦4 wt %, ≦3 wt %, or ≦2 wt %, in particular ≦1 wt % (wt % based on the entire shaped element). In particular, a shaped element according to the present invention contains no detergency builders.

Enzymes, electrolytes, nonaqueous solvents, pH adjusting agents, fluorescing agents, dyes, hydrotopes, foam inhibitors, silicone oils, anti-redeposition agents, graying inhibitors, shrinkage preventers, crease prevention agents, color transfer inhibitors, antimicrobial active substances, germicides, fungicides, antioxidants, corrosion inhibitors, antistatic agents, ironing adjuvants, proofing and impregnation agents, swelling and anti-slip agents, and/or UV absorbers are contained by preference in respective quantities of ≦30 wt %, ≦20 wt %, ≦15 wt %, ≦10 wt %, ≦9 wt %, ≦8 wt %, ≦7 wt %, ≦6 wt %, ≦5 wt %, ≦4 wt %, ≦3 wt %, or ≦2 wt %, in particular ≦1 wt % (wt % based on the entire shaped element). In particular, a shaped element according to the present invention can be free of each one of these substances, i.e. free of enzymes and/or free of electrolytes, etc.

Anionic surfactants can preferably be contained in the shaped elements according to the present invention. Anionic surfactants that are used are, for example, those of the sulfonate and sulfate types. Possible surfactants of the sulfonate type are, by preference, C₉₋₁₃ alkylbenzenesulfonates, olefin sulfonates, i.e. mixtures of alkene and hydroxyalkane sulfonates and disulfonates that are obtained, for example, from C₁₂₋₁₈ monoolefins having a terminal or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis or neutralization. Also suitable are the esters of α-sulfofatty acid (ester sulfonates), e.g. the α-sulfonated methyl esters of hydrogenated coconut, palm, or tallow fatty acids.

According to a preferred embodiment a shaped element according to the present invention contains anionic surfactants, by preference in quantities of at least 0.1 wt % based on the entire shaped element. According to another preferred embodiment, the agent according to the present invention is largely free of anionic surfactant, i.e. advantageously contains <5 wt %, by preference <1 wt %, in particular no anionic surfactant.

In addition to the aforesaid anionic surfactants, but also independently thereof, soaps can be contained in the shaped elements according to the present invention. Saturated fatty acid soaps, such as the salts of lauric acid, myristic acid, palmitic acid, stearic acid, hydrogenated erucic acid, and behenic acid, are suitable in particular, as are soap mixtures derived in particular from natural fatty acids, e.g. coconut, palm-kernel, or tallow fatty acids. The concentration of soap in the agent, independently of other anionic surfactants, is by preference no more than 3 wt % and in particular 0.5 to 2.5 wt %, based on the entire agent. According to a preferred embodiment, the agent according to the present invention is free of soap.

According to the present invention, nonionic surfactants can be contained in the shaped elements according to the present invention. Their content can be, for example, up to 2 or 3 or 5 wt %. Larger quantities of nonionic surfactant can also be contained, for example up to 5 wt % or 10 wt % or 15 wt % or 20 wt %, 30 wt %, 40 wt % or up to 50 wt % or even beyond if that is advisable, e.g. up to 60 wt %. Useful lower limits can be values of 0.01 wt %, 0.1 wt %, 1 wt %, 2 wt %, 3 wt %, or 4 wt %. Higher lower limits are also possible, for example 5 wt %, 6 wt %, 7 wt %, 8 wt %, 9 wt %, 10 wt %, 12 wt %, 14 wt %, 16 wt %, 18 wt %, 20 wt %, 25 wt %, 30 wt %, 35 wt %, or even 40 wt % (wt % based in each case on the entire shaped element).

By preference, however, the nonionic surfactants are contained in larger quantities, i.e. for example up to 50 wt %, advantageously from 0.1 to 40 wt %, particularly preferably from 0.5 to 30, and in particular from 2 to 25 wt %, based in each case on the entire agent. According to a preferred embodiment, a shaped element according to the present invention contains nonionic surfactants, by preference in quantities of at least 0.1 wt % based on the entire shaped element. According to another preferred embodiment, the agent according to the present invention is largely free of nonionic surfactant, i.e. advantageously contains <5 wt %, by preference <1 wt %, nonionic surfactant. Advantageously, all nonionic surfactants known from the existing art can be contained in the agents according to the present invention.

The nonionic surfactants used are by preference alkoxylated, advantageously ethoxylated, in particular primary alcohols having by preference 8 to 18 carbon atoms and an average of 1 to 12 mol ethylene oxide (EO) per mol of alcohol, in which the alcohol radical can be linear or preferably methyl-branched in the 2- position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm kernel, tallow, or oleyl alcohol, and an average of 2 to 8 EO per mol of alcohol. The preferred ethoxylated alcohols include, for example, C₁₂₋₁₄ alcohols having 3 EO to 6 EO, C₉₋₁₁ alcohols having 7 EO, C₁₃₋₁₅ alcohols having 3 EO, 5 EO, 7 EO, or 8 EO, C₁₂₋₁₈ alcohols having 3 EO, 5 EO, or 7 EO, and mixtures thereof, such as mixtures of C₁₂₋₁₄ alcohol having 3 EO and C₁₂₋₁₈ alcohol having 7 EO. The degrees of ethoxylation indicated represent statistical averages that can be an integer or a fractional number for a specific product.

Preferred alcohol ethoxylates exhibit a restricted distribution of homologs (narrow range ethoxylates, NRE). In addition to these nonionic surfactants, fatty alcohols having more than 12 EO can also be used. Examples of these are (tallow) fatty alcohols having 14 EO, 16 EO, 20 EO, 25 EO, 30 EO, or 40 EO.

The shaped elements according to the present invention can also, by preference, contain cationic surfactants. The shaped elements according to the present invention can contain one or more cationic surfactants, advantageously in quantities (based on the entire composition) from 0 to 30 wt %, even more advantageously greater than 0 to 20 wt %, by preference 0.01 to 10 wt %, in particular 0.1 to 5 wt %. Suitable minimum values can also be 0.5, 1, 2, or 3 wt %. According to a preferred embodiment, a shaped element according to the present invention contains cationic surfactants, by preference in quantities of at least 0.1 wt % based on the entire shaped element. According to another preferred embodiment, the agent according to the present invention is largely free of cationic surfactant, i.e. advantageously contains <5 wt %, by preference <1 wt %, in particular no cationic surfactant.

Further ingredients of the shaped elements according to the present invention can be inorganic and organic builder substances. Included among the inorganic builder substances are water-insoluble or non-water-soluble ingredients such as aluminosilicates and, in particular, zeolites. In a preferred embodiment, a shaped element according to the present invention contains no phosphate.

A shaped element according to the present invention can contain soluble builders by preference in quantities from 0.1 wt % to 40 wt %, preferably 5 wt % to 25 wt %, and particularly preferably 10 wt % to 20 wt %, based on the total weight of the agent, sodium carbonate being particularly preferred as a soluble builder. Provision can also advantageously be made, however, for the agent according to the present invention to contain less than 10 wt %, for example less than 5 wt %, soluble builder. According to another preferred embodiment, the agent according to the present invention is free of soluble builder.

A finely crystalline synthetic zeolite containing bound water that is usable is by preference zeolite A and/or zeolite P. Zeolite MAP® (commercial product of the Crosfield Co.) is particularly preferred as zeolite P. Also suitable, however, are zeolite X as well as mixtures of A, X, and/or P.

In a preferred embodiment of the invention, all the inorganic constituents that are contained, i.e. all the constituents to be incorporated in the context of the method, are by preference to be water-soluble. Builder substances other than the aforesaid zeolites are therefore used in these embodiments.

In a preferred embodiment of the invention, carbonates and silicates, in particular, are used as inorganic builder substances.

Particularly preferred inorganic water-soluble builders are alkali-metal carbonates and alkali-metal bicarbonates; sodium and potassium carbonate and in particular sodium carbonate are among the preferred embodiments. The concentration of alkali-metal carbonates in particular in zeolite-free agents can vary over a very wide range and is by preference 1 to 50 wt %, advantageously 5 to 40 wt %, in particular 8 to 30 wt %, the concentration of alkali-metal carbonates usually being higher than that of (X-)amorphous silicates. According to another preferred embodiment, a shaped element is free of alkali-metal carbonates.

Usable organic builder substances are, for example, the polycarboxylic acids, usable in the form of their alkali and (in particular) sodium salts, such as citric acid, adipic acid, succinic acid, glutaric acid, tartaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof. The acids per se can also be used. The acids typically also possess, in addition to their builder effect, the property of an acidifying component, and thus serve also to establish a lower and milder pH. Worthy of mention in this context are, in particular, citric acid, succinic acid, glutaric acid, adipic acid, gluconic acid, and any mixtures thereof.

Polycarboxylates are also suitable as organic builders; these are, for example, the alkali-metal salts of polyacrylic acid or polymethacrylic acid, for example those having a relative molecular weight from 500 to 70,000 g/mol. The molar weights indicated for polymeric polycarboxylates are, for purposes of this document, weight-averaged molar weights Mw of the respective acid form that were determined in principle by means of gel permeation chromatography (GPC), a UV detector having been used. The measurement was performed against an external polyacrylic acid standard that yields realistic molecular weight values because of its structural affinity with the polymers being investigated. These indications deviate considerably from the molecular weight indications in which polystyrenesulfonic acids are used as a standard. The molar weights measured against polystyrenesulfonic acids are usually much higher than the molar weights indicated in this document.

The shaped elements according to the present invention contain polymers. Suitable polymers encompass, in particular, polyacrylates, which preferably have a molecular weight from 2000 to 20,000 g/mol. Because of their superior solubility, from this group the short-chain polyacrylates that have molar weights from 2000 to 10,000 g/mol, and particularly preferably from 3000 to 5000 g/mol, may in turn be preferred.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, by preference 20,000 to 50,000 g/mol, and in particular 30,000 to 40,000 g/mol.

Particularly suitable polymer(s) can be selected from:
i) polyacrylic acids and salts thereof,
ii) polymethacrylic acids and salts thereof,
iii) polyvinylpyrrolidone,
iv) vinylpyrrolidone/vinyl ester copolymers,
v) cellulose, starch, and guar ethers,
vi) polyvinyl acetates, polyvinyl alcohols, and copolymers thereof,
vii) graft copolymers of polyethylene glycols and vinyl acetate
viii) alkylacrylamide/acrylic acid copolymers and salts thereof
ix) alkylacrylamide/methacrylic acid copolymers and salts thereof
x) alkylacrylamide/methylmethacrylic acid copolymers and salts thereof
xi) alkylacrylamide/acrylic acid/alkylaminoalkyl(meth)acrylic acid copolymers and salts thereof
xii) alkylacrylamide/methacrylic acid/alkylaminoalkyl(meth)acrylic acid copolymers and salts thereof
xiii) alkylacrylamide/methylmethacrylic acid/alkylaminoalkyl(meth)acrylic acid copolymers and salts thereof
xiv) alkylacrylamide/alkyl methacrylate/alkylaminoethyl methacrylate/alkyl methacrylate copolymers and salts thereof
xv) copolymers of
xv-i) unsaturated carboxylic acids and salts thereof
xv-ii) cationically derivatized unsaturated carboxylic acids and salts thereof
xvi) acrylamidoalkyltrialkylammonium chloride/acrylic acid copolymers and alkali and ammonium salts thereof,
xvii) acrylamidoalkyltrialkylammonium chloride/methacrylic acid copolymers and alkali and ammonium salts thereof,
xviii) methacroylethyl betaine/methacrylate copolymers,
xix) vinyl acetate/crotonic acid copolymers,
xx) acrylic acid/ethyl acrylate/n-tert.-butylacrylamide terpolymers,
xxi) graft polymers of vinyl esters, esters of acrylic acid or methacrylic acid alone or mixed, copolymerized with crotonic acid, acrylic acid, or methacrylic acid with polyalkylene oxides and/or polykalkylene glycols,
xxii) grafted copolymers from the copolymerization of
xxii-i) at least one monomer of the nonionic type,
xxii-ii) at least one monomer of the ionic type,
xxiii) copolymers obtained by copolymerization of at least one monomer of each of the three following groups:
xxiii-i) esters of unsaturated alcohols and short-chain saturated carboxylic acids and/or esters of short-chain saturated alcohols and unsaturated carboxylic acids,
xxiii-ii) unsaturated carboxylic acids,
xxiii-iii) esters of long-chain carboxylic acids and unsaturated alcohols and/or esters of the carboxylic acids of group d6ii) with saturated or unsaturated, straight-chain or branched C₈₋₁₈ alcohols,
xxiv) biopolymers, in particular xanthan, carrageenan, agar, etc.

The concentration of organic builder substances in the shaped elements can vary over a wide range. Concentrations from 0.5 to 20 wt % are preferred, concentrations in particular of at most 10 wt % being particularly well received. According to another preferred embodiment, a shaped element according to the present invention is free of organic builder substances.

Be it noted at this juncture that unless otherwise indicated, the indication “wt %” refers in each case to the entire shaped element, i.e. including an optional coating.

The shaped elements according to the present invention can comprise components from the classes of the graying inhibitors (dirt carriers), the neutral salts, and/or the textile-softening adjuvants (e.g. cationic surfactants), which is preferred.

Advantageously, avivage agents such as, for example, fatty acid derivatives, silicone oils, sheet silicates such as, for example, bentonite, and/or cationic surfactants, by preference quaternary ammonium compounds, in particular esterquats, are contained, in quantities from e.g. 0.1 wt % to ≦50 wt %, by preference ≦40 wt %, ≦30 wt %, ≦20 wt %, ≦10 wt %, ≦8 wt %, ≦7 wt %, ≦6 wt %, ≦5 wt %, ≦4 wt %, ≦3 wt %, or ≦2 wt %, in particular ≦1 wt % (wt % based on the entire shaped element). According to a particular embodiment, a shaped element according to the present invention contains no avivage agent. Especially if the shaped element contains avivage agent, but also irrespective thereof, it is suitable by preference for use in laundry dryers. A further subject of the invention is therefore a mechanized laundry drying method in an automatic laundry dryer using a shaped element according to the present invention that by preference contains avivage agent and/or skin-care agent.

The shaped elements according to the present invention can advantageously encompass skin-care agents, for example in quantities from 0.1 wt % to ≦30 wt %, by preference ≦20 wt %, ≦15 wt %, ≦10 wt %, ≦9 wt %, ≦8 wt %, ≦7 wt %, ≦6 wt %, ≦5 wt %, ≦4 wt %, ≦3 wt %, or ≦2 wt %, in particular ≦1 wt % (wt % based on the entire shaped element). According to a particular embodiment a shaped element according to the present invention contains no skin-care agents.

Skin-care agents can be, in particular, those agents that can impart a sensory advantage to the skin, for example by delivering lipids and/or humectant factors to it. Skin-care agents can be, for example, proteins, amino acids, lecithins, lipoids, phosphatides, plant extracts, vitamins; fatty alcohols, fatty acids, fatty acid esters, waxes, vaselines, paraffins can likewise act as skin-care agents.

In a preferred embodiment, the products according to the present invention contain both skin-care agents and avivage agents such as, for example, quaternary ammonium compounds, by preference esterquats.

The shaped elements according to the present invention can furthermore be conditioning agents, and can contain components in accordance therewith. The term “conditioning” is preferably to be understood for purposes of this invention as the avivage treatment of textiles, materials, and woven fabrics. Conditioning imparts positive properties to the textiles, for example improved softness, enhanced shine and color brilliance, an improved scent impression, decreased pilling, easier ironing thanks to decreased frictional properties, a reduction in creasing and static charge, and an inhibition of color transfer in the case of colored textiles.

In order to improve softness and avivage properties, the agents according to the present invention can comprise softener components. Examples of such compounds are quaternary ammonium compounds, cationic polymers, and emulsifiers, such as those used in hair care agents and also in agents for textile avivage. These softening compounds, which are also described in further detail below, can be contained in all agents according to the present invention, but in particular in the conditioning agents or in agents aimed at having a softening effect.

Suitable examples are quaternary ammonium compounds of formulas (III) and (IV),

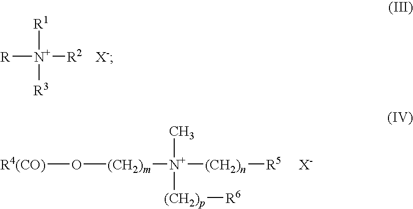

in which in (III), R and R¹ denote an acyclic alkyl radical having 12 to 24 carbon atoms; R² denotes a saturated C₁-C₄ alkyl or hydroxyalkyl radical; and R³ either is identical to R, R¹, or R² or denotes an aromatic radical. X⁻ denotes either a halide, methosulfate, methophosphate, or phosphate ion, and mixtures thereof. Examples of cationic compounds of formula (III) are didecyldimethylammonium chloride, ditallowdimethylammonium chloride, or dihexadecylammonium chloride.

Compounds of formula (IV) are so-called esterquats. Esterquats are characterized by outstanding biodegradability. Here R⁴ denotes an aliphatic alkyl radical having 12 to 22 carbon atoms with 0, 1, 2, or 3 double bonds; R⁵ denotes H, OH, or O(CO)R⁷; and R⁶ denotes, independently of R⁵, H, OH, or O(CO)R⁸, R⁷ and R⁸ each denoting, mutually independently, an aliphatic alk(en)yl radical having 12 to 22 carbon atoms with 0, 1, 2, or 3 double bonds. m, n, and p can each, mutually independently, have a value of 1, 2, or 3. X⁻ can be either a halide, methosulfate, methophosphate, or phosphate ion, as well as mixtures thereof. Compounds that contain the group O(CO)R⁷ for R⁵, and alkyl radicals having 16 to 18 carbon atoms for R⁴ and R⁷, are preferred. Compounds in which R⁶ additionally denotes OH are particularly preferred. Examples of compounds of formula (IV) are methyl-N-(2-hydroxyethyl)-N,N-di(tallowacyloxyethyl)ammonium methosulfate, bis-(palmitoyl)ethylhydroxyethylmethylammonium methosulfate, or methyl-N,N-bis(acyloxyethyl)-N-(2-hyd roxyethyl)am mon ium methosulfate. If quaternized compounds of formula (IV) having unsaturated alkyl chains are used, those acyl groups whose corresponding fatty acids have an iodine number of between 5 and 80, preferably between 10 and 60, and in particular between 15 and 45, and that have a cis/trans isomer ratio (in wt %) greater than 30:70, preferably greater than 50:50, and in particular greater than 70:30, are preferred. Commercial examples are the methylhydroxyalkyldialkoyloxyalkylammonium methosulfates marketed by Stepan under the trade name Stepantex®, or the products of Cognis known as Dehyquat®, or the products of Goldschmidt-Witco known as Rewoquat®.

Alkylated quaternary ammonium compounds of which at least one alkyl chain is interrupted by an ester group and/or amido group, in particular N-methyl-N-(2-hydroxyethyl)-N, N-(ditallowacyloxyethyl)am monium methosulfate, are particularly preferred.

Softeners such as, for example, bentonite can be contained in an agent according to the present invention, for example by preference a conditioning agent, in quantities of at least 0.1 wt %, usually 0.1 to 30 wt %, by preference 0.2 to 20 wt %, and in particular 0.5 to 10 wt %, based in each case on the entire agent.

In a preferred embodiment, a shaped element according to the present invention such as, for example, in particular a conditioning agent, can if applicable contain one or more complexing agents.

Complexing agents (INCI: Chelating Agents), also called sequestering agents, are ingredients that are capable of complexing and inactivating metal ions, for example in order to reduce their disadvantageous effects on the stability or appearance of the agents, for example clouding. It is important on the one hand to complex the calcium and magnesium ions of water hardness, which are incompatible with numerous ingredients. Complexing of the ions of heavy metals such as iron or copper slows down oxidative decomposition of the finished agents.

One particularly preferred complexing agent is etidronic acid (1-hydroxyethylidene-1,1-diphosphonic acid, 1-hydroxyethyane-1,1-diphosphonic acid, HEDP, acetophosphonic acid, INCI: Etidronic Acid), including salts thereof. In a preferred embodiment, a shaped element according to the present invention therefore contains etidronic acid and/or one or more salts thereof as a complexing agent.

A shaped element according to the present invention such as, for example, in particular a conditioning agent, advantageously contains complexing agents in a quantity usually from 0 to 20 wt %, by preference 0.1 to 15 wt %, in particular 0,5 to 10 wt %, particularly preferably 1 to 8 wt %, extremely preferably 1.5 to 6 wt %, based on the entire agent.

In a further preferred embodiment, a shaped element according to the present invention such as, in particular, a conditioning agent, if applicable contains one or more enzymes. According to another preferred embodiment, however, the product according to the present invention is free of enzymes.

Suitable enzymes are, in particular, those in the classes of hydrolases, such as proteases, esterases, lipases or lipolytically active enzymes, amylases, cellulases and other glycosyl hydrolases, and mixtures of the aforesaid enzymes. All these hydrolases contribute, in the laundry, to the removal of stains such as protein-, grease-, or starch-containing stains, and graying. Cellulases and other glycosyl hydrolases can moreover contribute to color retention and to enhanced textile softness by removing pilling and microfibrils. Oxidoreductases can also be used for bleaching and to inhibit color transfer.

The enzymes can be adsorbed onto carrier materials as shaped elements, or can be embedded in gel-coated fashion, in order to protect them from premature breakdown. The proportion of enzymes, enzyme mixtures, or enzyme granulates can be, for example, approximately 0.1 to 5 wt %, by preference 0.12 to approximately 2 wt %, based on the entire agent.

The shaped elements according to the present invention (e.g. conditioning agents) can if applicable contain bleaching agents. Among the compounds yielding H₂O₂ in water and serving as bleaching agents, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as persulfates or persulfuric acid. Also usable is the urea peroxohydrate percarbamide, which can be described by the formula H₂N—CO—NH₂·H₂O₂. Especially when the agents are used for cleaning hard surfaces, for example in automatic dishwashing, they can if desired also contain bleaching agents from the group of the organic bleaching agents, although the use thereof is also possible, in principle, in agents for textile laundering. Typical organic bleaching agents are the diacyl peroxides such as, for example, dibenzoyl peroxide. Further typical organic bleaching agents are the peroxy acids; the alkylperoxy acids and arylperoxy acids are mentioned in particular as examples. Preferred representatives are peroxybenzoic acid and its ring-substituted derivatives, such as alkylperoxybenzoic acids, but also peroxy-α-naphthoic acid and magnesium monoperphthalate; the aliphatic or substituted aliphatic peroxy acids, such as peroxylauric acid, peroxystearic acid, ε-phthalimidoperoxycaproic acid (phthaloiminoperoxyhexanoic acid, PAP), o-carboxybenzamidoperoxycaproic acid, N-nonenylamidoperadipic acid, and N-nonenylamidopersuccinates; and aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid, can be used. According to another preferred embodiment, however, the product according to the present invention is free of bleaching agent.

Dyes can be used in the shaped element according to the present invention; the quantity of one or more dyes must be selected to be so small that no visible residues remain after application of the agent. By preference, he agent according to the present invention is free of dyes.

A shaped element according to the present invention can optionally encompass a daylight-active bleaching agent, advantageously based on titanium dioxide. This can be contained in the actual shaped element and/or in an optional coating. A daylight-active bleaching agent can advantageously utilize radiation of the visible region of the spectrum, perceivable by the human eye and having wavelengths between 300 and 1200 nm, by preference between 380 and 800 nm, for the purpose of photo-bleaching, and can thus exert a general cleaning effect, for example as a result of the incidence of daylight.

The optional titanium dioxide is by preference a modified titanium dioxide, by preference a carbon-modified titanium dioxide.

The optional (by preference, modified) titanium dioxide can be contained in the agent according to the present invention, for example, in quantities advantageously from 0.000001 to 25 wt %, by preference 0.01 to 5 wt %, based on the entire agent. The lower limit for the (by preference, modified) titanium dioxide can also be 0.00001 wt %, 0.00005 wt %, 0.0001 wt %, 0.0005 wt %, 0.001 wt %, or 0.005 wt %, based on the entire agent. The upper limit for the (by preference, modified) titanium dioxide can also be 20 wt %, 15 wt %, 10 wt %, 5 wt %, 1 wt %, 0.5 wt %, 0.1 wt %, 0.05 wt %, 0.01 wt %, 0.005 wt %, 0.001 wt %, 0.0005 wt %, 0.0001 wt %, 0.00005 wt %, 0.00001 wt %, or 0.000005 wt %, based on the entire agent. “The entire agent” means the entire shaped element, including the optional coating.

A further subject of the invention is constituted by a method for treating a textile or hard surface, comprising bringing the textile or hard surface into contact with a shaped element according to the present invention, during and/or followed by an exposure of the surface of the treated material to light having a wavelength in the range from 300 to 1200 nm, by preference 400 to 800 nm. For a preferred exertion of the effectiveness of the optional photo-bleaching agent, the presence of, by preference, oxygen and/or water (e.g. from air, i.e. atmospheric moisture) is necessary. The dissolved oxygen present in water, or the oxygen dissolved in moisture, or atmospheric oxygen, is sufficient, for example, for this. Illumination can also take place in a treatment bath.

The (by preference, modified) titanium dioxide, in particular carbon-modified titanium dioxide, can act as a light-active bleaching agent by utilizing the radiation of the visible region of the spectrum, advantageously perceivable by the human eye and having wavelengths between 380 and 800 nm, for the purpose of photo-bleaching, thus exerting a general cleaning effect, for example as a result of the incidence of daylight.

The light activity of the light-active bleaching agent (by preference, modified titanium dioxide) advantageously refers to natural or artificial light having a wavelength in the region from 300 to 1200 nm, by preference between 380 and 800 nm.

Advantageously, even the light that is incident through glass windows into enclosed living spaces (diffuse daylight) is sufficient to achieve the cleaning that is aimed for (e.g. definite diminution in colored stains). Even light from industrial light sources (artificial light), for example from commercially available incandescent lamps (light bulbs), halogen lamps, fluorescent tubes, compact fluorescent lamps (energy-saving lamps), and from light sources based on light-emitting diodes, is sufficient to bring about the desired cleaning (e.g. spot removal).

The shaped element having (by preference, modified) TiO₂ exerts a general cleaning effect and performs very effectively in terms of removing, in particular, colored stains with the aid of light, in particular using the radiation of the visible region of the spectrum, perceivable by the human eye and having wavelengths between 380 and 800 nm. Stress on the treated substrates is low in this context. Advantageously, the washing, care-providing, or cleaning agent can also exert a general cleaning effect with the aid of UV radiation (wavelength 380 to 200 nm, by preference 380 to 320 nm), and by preference can also perform effectively in terms of removing colored stains.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

What is claimed:

1. A delivery system for a washing- or cleaning-agent shaped element, comprising a withdrawal receptacle and a strip-shaped, sheet-shaped, disk-shaped, layer-shaped, plate-shaped, or web-shaped washing- or cleaning-agent shaped element supplied in the withdrawal receptacle, the shaped element comprising at least 20 wt % of a water-soluble polymer and a washing- or cleaning-able substance.

2. The system of claim 1, wherein the shaped element comprises a single ply or of a laminate of more than one ply and optionally further comprises a coating.

3. The system of claim 1, wherein the shaped element comprises a film of flexible material and the washing- or cleaning-able substance is applied in the film or as a layer on the film.

4. The system of claim 1, wherein the washing- or cleaning-able substance comprises a surfactant, an optical brightener, or a bleaching agent.

5. The system of claim 1, wherein the shaped element comprises an optionally water-dispersible or water-soluble surface adhesive layer, the adhesive layer comprising a polymerizate that is adhesive at room temperature under pressure or in the presence of moisture.

6. The system of claim 5, wherein the adhesive layer comprises washing- or cleaning-able substance.

7. The system of claim 6, wherein the washing- or cleaning-able substance is dispersed in the polymerizate.

8. The system of claim 6, wherein the washing- or cleaning-able substance comprising the adhesive layer comprises a viscous liquid or solid particles.

9. The system of claim 8, wherein the viscous liquid comprises a gel.

10. The system of claim 5, wherein the adhesive layer has a removable protective film.

11. The system of claim 1, wherein the withdrawal receptacle comprises a flexible or inflexible, optionally reclosable receptacle at least partly enclosing the shaped element.

12. The system of claim 11, wherein the withdrawal receptacle comprises a box, pouch, or envelope.

13. The system of claim 11, wherein the withdrawal receptacle comprises a dosing dispenser.

14. The system of claim 1, comprising a roll on which a plurality of the shaped elements are wound.

15. The system of claim 14, wherein the shaped elements are provided with separation points for single-portion withdrawal.

16. The system of claim 14, wherein the withdrawal receptacle comprises a tape dispenser.

17. The system of claim 14, wherein the withdrawal receptacle comprises a film transfer roller.

18. A method for manufacturing an aqueous system having cleaning ability, comprising withdrawing at least a portion of the shaped element supplied in the washing- or cleaning-agent delivery system of claim 1, and adding the at least a portion of the shaped element withdrawn to an aqueous system.

19. A method of local spot treatment of a spot on a substrate, comprising withdrawing at least a portion of the shaped element supplied in the washing- or cleaning-agent delivery system of claim 1, and applying the at least a portion of the shaped element in adhering fashion onto the spot to be treated.

20. The method of claim 19, wherein the spot comprises one or more anthocyanins, betalains, carotenoids, chlorophylls, anthranoids, quinones, flavonoids, curcuma dyes, hemoglobin, brown tannins, brown humic acids, or industrial dyes.

21. The method of claim 19, further comprising moistening the at least a portion of the shaped element withdrawn or the spot to be treated before application of the at least a portion of the shaped element to the spot, resulting in adhesion between the at least a portion of the shaped element and the substrate to be treated.
